(19) United States
(12) Patent Application Publication
(10) Pub. No.: US 2009/0089079 A1
(43) Pub. Date: Apr. 2, 2009

(54) System and method for determining whether to issue an alert to consider prophylaxis for a risk condition

(75) Inventors: Samuel S. Goldhaber, Chestnut Hill, MA (US); Nils Kucher, Mannedorf (CH); Marilyn Paterno, Norwood, MA (US)

Correspondence Address: WOLF GREENFIELD & SACKS, P.C., 600 ATLANTIC AVENUE, BOSTON, MA, 02210-2206, US

(73) Assignee: The Brigham and Women's Hospital, Inc., Boston, MA (US)

(21) Appl. No.: 11/667,394

(22) PCT Filed: Nov. 9, 2005
(86) PCT No.: PCT/US05/40397

§ 371 Date: Dec. 1, 2008

Related U.S. Application Data
(60) Provisional application No. 60/626,614, filed on Nov. 9, 2004.

(51) Int. Cl. G06Q 50/00

(52) U.S. Cl. 705/2

(57) ABSTRACT

Disclosed herein is a system and method for determining whether to issue an alert to consider prophylaxis (e.g., mechanical and/or pharmacological) with respect to a risk condition (e.g., risk of VTE, DVT and/or PE). One or more sources of patient information are queried to retrieve patient information for a set of patients. From this retrieved patient information, it is determined whether any risk factors of a set of risk factors are satisfied for each such patient. For each patient for which one or more risk factors are satisfied, a respective value and/or classification is assigned to each risk factor. The values and/or classifications are combined to produce a combined value, and it is determined from the combined value whether the patient has the risk condition. If the patient has the risk condition, an alert is issued (e.g., on a display screen) to a health care provider for consideration of prophylaxis.

### FIELD OF THE INVENTION

This invention relates to the field of preventive medical treatment and, in particular to the preventive treatment to reduce the incidence of venous thromboembolism among hospitalized patients.

### BACKGROUND

Despite detailed European and North American consensus guidelines, implementation of venous thromboembolism (VTE) prophylaxis continues to be problematic. VTE is a disease comprising the pre-fatal condition of deep venous thrombosis (DVT) and the potentially fatal condition of pulmonary embolism (PE). When the DVTs “break off” from the pelvic and deep leg veins, they travel through the inferior vena cava through the right atrium and right ventricle, and into the pulmonary arteries where they cause major symptoms and sometimes death.

Randomized controlled trials of hospitalized medical patients have shown that VTE prophylaxis is effective and safe in preventing VTE. Yet, European and North American surveys show persistent underutilization of prophylaxis. In one study, in a registry of 5,451 consecutive patients with ultrasound-confirmed DVT from one hundred eighty three United States institutions, only 42% of inpatients had received prophylaxis within thirty days prior to developing acute DVT.

At Brigham and Women's Hospital in Boston, Mass. (BWH), awareness of risk factors for DVT and PE, as well as the effectiveness of prevention strategies, have been pervasive for more than thirty years. Frequent educational programs focus on the necessity of VTE prophylaxis. Although BWH has utilized an order entry system programmed to suggest prophylaxis if an order for “bed rest” is entered, a two-year audit found that only 52% of patients who developed DVT while hospitalized for other reasons had received prophylaxis.

The BWH order entry systems and other known Clinical Decision Support Systems (CDSSs) for prevention of VTE only suggest or prescribe prophylaxis in response to information being entered onto the system. For example, the BWH system only suggests prophylaxis in response to an order of “bed rest” being entered, such as a post-surgical order. Other known CDSSs only suggest a prescription after an order has been entered, and a discrepancy has been determined between the order and information in a database, and then only at the time of order entry.

Accordingly, a need exists for a more effective system and method for identifying patients who can benefit from prophylaxis to avoid conditions such as VTE. Preferably, such a system and method would alert physicians to the advisability of prophylaxis independently of order entry.

### SUMMARY

In an effort to address this need, there is shown herein a system and computer-implemented method for monitoring the electronic records of hospitalized patients, identifying those who appear to be likely to benefit from prophylaxis to prevent VTE, and alerting the appropriate health care provider(s).

In an embodiment of the invention, it is determined whether to issue an alert for consideration of prophylaxis for at least one patient with respect to a risk condition. For each risk factor of a set of risk factors, it is determined whether the risk factor is satisfied for the at least one patient, and, for each satisfied risk factor, a respective pre-selected value is assigned. The assigned values are combined for the at least one patient to produce a risk score, and an alert is issued to consider prophylaxis for the at least one patient if the risk score satisfies one or more predefined criteria.

In an aspect of this embodiment, it is determined whether the risk factor is satisfied for at least a subset of a patient population.

In another aspect of this embodiment, it is determined whether the risk score is equal to or greater than a predefined threshold value.

In another aspect of this embodiment, the acts of determining, assigning, combining and issuing are repeated at a predetermined frequency, for example, daily.

In yet another aspect of this embodiment, the act of determining includes accessing one or more patient information data sources.

In another aspect of this embodiment, the act of determining includes, for a plurality of patients, determining for each risk factor of a set of risk factors, whether the risk factor is satisfied by one or more of the plurality of patients by accessing information from the one or more patient data sources for each patient.

In another aspect of this embodiment, the risk condition is Venous Thromboembolism.

In yet another aspect of this embodiment, the risk condition is Deep Vein Thrombosis.

In another aspect of this embodiment, the risk condition is Pulmonary Embolism.

In another aspect of this embodiment, the set of risk factors includes two or more of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors includes the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In yet another aspect of this embodiment, the set of risk factors consists of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors has the following pre-selected values: patient has been diagnosed with cancer=3; patient has had a prior occurrence of a Venous Thromboembolism=3; patient has been diagnosed with hypercoagulability=3; patient has had major surgery=2; patient has not had major surgery and is currently on bed rest=1; patient is of advanced age=1; patient is obese=1; and patient is receiving hormone replacement therapy or uses oral contraceptives=1.

In another aspect of this embodiment, it is determined whether the risk score is equal to or greater than 4.

In another aspect of this embodiment, the set of risk factors are divided into one or more classifications, and it is determined whether one or more predefined combinations of risk factors have been satisfied, based on the classifications of the satisfied risk factors.

In yet another aspect of this embodiment, each risk factor is classified as a major risk factor, intermediate risk factor or minor risk factor, and issuing an alert includes issuing an alert to consider prophylaxis for the at least one patient if: at least one major risk factor is satisfied and at least one of an intermediate or minor risk factor is satisfied; or at least two intermediate risk factors are satisfied; or at least one major intermediate risk factor and at least two minor risk factors are satisfied; or at least four minor risk factors are satisfied.

In another aspect of this embodiment, combining the assigned values includes adding the assigned values for the at least one patient to produce the risk score.

In another aspect of this embodiment, issuing the alert includes displaying the alert on a display device.

In yet another aspect of this embodiment, issuing the alert includes directing the alert to one or more appropriate health care providers.

One or more acts of the preceding embodiment and/or one or more aspects thereof may be implemented using a computer or other type of computational system.

Aspects of this embodiment of the invention include any suitable combination of the foregoing aspects and/or variations thereof.

In another embodiment of the invention, a system is provided for determining whether to issue an alert for consideration of prophylaxis for at least one patient with respect to a risk condition. The system includes a risk condition determination module to determine whether the at least one patient has the risk condition by determining, for each risk factor of a set of risk factors, whether the risk factor is satisfied for the at least one patient, assigning, for each satisfied risk factor, a respective pre-selected value, combining the assigned values for the at least one patient to produce a risk score, and determining if the risk score satisfies one or more predefined criteria. The system also includes an alert module to issue an alert to consider prophylaxis for the at least one patient if the risk score satisfies the one or more predefined criteria.

In an aspect of this embodiment, the risk condition determination module includes means for determining whether the at least one patient has the risk condition.

In another aspect of this embodiment, the risk condition determination module is operative to determine, for each risk factor of a set of risk factors, whether the risk factor is satisfied for at least a subset of a patient population.

In another aspect of this embodiment, the risk condition determination module is operative to determine whether the risk score is equal to or greater than a predefined threshold value.

In another aspect of this embodiment, the risk condition determination module is operative to determine whether at least one patient has the risk condition at a predetermined frequency, for example, daily.

In another aspect of this embodiment, the system includes a querying module to access one or more patient information data sources.

In another aspect of this embodiment, the risk condition determination module is operative to determine, for a plurality of patients, for each risk factor of a set of risk factors, whether the risk factor is satisfied by one or more of the plurality of patients. In this aspect, the querying module is operative to access information, on which the determination is based at least in part, from the one or more patient data sources for each patient.

In yet another aspect of this embodiment, the risk condition is Venous Thromboembolism.

In another aspect of this embodiment, the risk condition is Deep Vein Thrombosis.

In another aspect of this embodiment, the risk condition is Pulmonary Embolism.

In another aspect of this embodiment, the set of risk factors includes two or more of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In yet another aspect of this embodiment, the set of risk factors includes the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors consists of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors has the following pre-selected values: patient has been diagnosed with cancer=3; patient has had a prior occurrence of a Venous Thromboembolism=3; patient has been diagnosed with hypercoagulability=3; patient has had major surgery=2; patient has not had major surgery and is currently on bed rest=1; patient is of advanced age=1; patient is obese=1; and patient is receiving hormone replacement therapy or uses oral contraceptives=1.

In another aspect of this embodiment, the risk condition determination module is operative to determine whether the risk score is equal to or greater than 4.

In yet another aspect of this embodiment, the set of risk factors are divided, into one or more classifications, and the risk condition determination module is operative to determine whether one or more predefined combinations of risk factors have been satisfied, based on the classifications of the satisfied risk factors.

In another aspect of this embodiment, each risk factor is classified as a major risk factor, intermediate risk factor or minor risk factor, and the alert module is operative to issue an alert to consider prophylaxis for the at least one patient if: at least one major risk factor is satisfied and at least one of an intermediate or minor risk factor is satisfied; or at least two intermediate risk factors are satisfied; or at least one major intermediate risk factor and at least two minor risk factors are satisfied; or at least four minor risk factors are satisfied.

In another aspect of this embodiment, the risk condition determination module is operative to add the assigned values for the at least one patient to produce the risk score.

In another aspect of this embodiment, the alert module is operative to display the alert on a display device.

In yet another aspect of this embodiment, the alert module is operative to direct the alert to one or more appropriate health care providers.

Aspects of this embodiment of the invention include any suitable combination of the foregoing aspects and/or variations thereof.

In another embodiment of the invention, a computer program product is provided. The computer program product includes a computer-readable medium, and computer-readable signals, stored on the computer-readable medium, that define instructions that, as a result of being executed by a computer, control the computer to perform a process of determining whether to issue an alert for consideration of prophylaxis for at least on patient with respect to a risk condition. The process includes acts of: (A) for each risk factor of a set of risk factors, determining whether the risk factor is satisfied for the at least one patient; (B) for each satisfied risk factor, assigning a respective pre-selected value; (C) combining the assigned values for the at least one patient to produce a risk score; and (D) issuing an alert to consider prophylaxis for the at least one patient if the risk score satisfies one or more predefined criteria.

In an aspect of this embodiment, the act (A) is performed for at least a subset of a patient population.

In another aspect of this embodiment, it is determined whether the risk score is equal to or greater than a predefined threshold value.

In another aspect of this embodiment, the acts (A), (B), (C) and (D) are repeated at a predetermined frequency, for example, daily.

In yet another aspect of this embodiment, the act (A) includes accessing one or more patient information data sources.

In another aspect of this embodiment, the act (A) includes, for a plurality of patients, determining for each risk factor of a set of risk factors, whether the risk factor is satisfied by one or more of the plurality of patients by accessing information from the one or more patient data sources for each patient.

In another aspect of this embodiment, the risk condition is Venous Thromboembolism.

In yet another aspect of this embodiment, the risk condition is Deep Vein Thrombosis.

In another aspect of this embodiment, the risk condition is Pulmonary Embolism.

In another aspect of this embodiment, the set of risk factors includes two or more of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors includes the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In yet another aspect of this embodiment, the set of risk factors consists of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors has the following pre-selected values: patient has been diagnosed with cancer=3; patient has had a prior occurrence of a Venous Thromboembolism=3; patient has been diagnosed with hypercoagulability=3; patient has had major surgery=2; patient has not had major surgery and is currently on bed rest=1; patient is of advanced age=1; patient is obese=1; and patient is receiving hormone replacement therapy or uses oral contraceptives=1.

In another aspect of this embodiment, the process includes an act of determining whether the risk score is equal to or greater than 4.

In another aspect of this embodiment, the process includes dividing the set of risk factors into one or more classifications, and determining whether one or more predefined combinations of risk factors have been satisfied, based on the classifications of the satisfied risk factors.

In yet another aspect of this embodiment, each risk factor is classified as a major risk factor, intermediate risk factor or minor risk factor, and the act (D) includes issuing an alert to consider prophylaxis for the at least one patient if: at least one major risk factor is satisfied and at least one of an intermediate or minor risk factor is satisfied; or at least two intermediate risk factors are satisfied; or at least one major intermediate risk factor and at least two minor risk factors are satisfied; or at least four minor risk factors are satisfied.

In another aspect of this embodiment, the act (C) includes adding the assigned values for the at least one patient to produce the risk score.

In another aspect of this embodiment, the act (D) includes displaying the alert on a display device.

In yet another aspect of this embodiment, the act (D) includes directing the alert to one or more appropriate health care providers.

Aspects of this embodiment of the invention include any suitable combination of the foregoing aspects and/or variations thereof.

In another embodiment of the invention, it is determined whether to issue an alert for consideration of prophylaxis for at least one patient with respect to a risk condition. For each of a set of risk factors, each risk factor having a risk classification, it is determined whether the risk factor is satisfied for the at least one patient. An alert is issued to consider prophylaxis for the at least one patient if one or more predefined combinations of risk factors are satisfied, based on the classifications of the satisfied risk factors.

In an aspect of this embodiment, each risk factor is classified as a major risk factor, an intermediate risk factor or a minor risk factor, and issuing an alert includes issuing an alert to consider prophylaxis for the at least one patient if: at least one of the major risk factor is satisfied and at least one of an intermediate or minor risk factor is satisfied; or at least two intermediate risk factors are satisfied; or at least one major intermediate risk factor and at least two minor risk factors are satisfied; or at least four minor risk factors are satisfied.

In another aspect of this embodiment, the major risk factors have a pre-selected value=3, the intermediate factors have a pre-selected value=2 and the minor factors have a pre-selected value=1. For each satisfied risk factor for the at least one patient, one of the pre-selected values is assigned to the risk factor based on the classification of the risk factor, and the assigned values for the at least one patient are added to produce a risk score. In this aspect, issuing an alert includes issuing the alert if the risk score is equal to or greater than 4.

In another aspect of this embodiment, the act of determining is performed for at least a subset of a patient population.

In yet another aspect of this embodiment, the acts of determining and issuing are performed at a predetermined frequency, for example, daily.

In another aspect of this embodiment, the act of determining includes accessing one or more patient information data sources.

In another aspect of this embodiment, the act of determining includes, for a plurality of patients, for each risk factor of a set of risk factors, determining whether the risk factor is satisfied by one or more of the plurality of patients by accessing information from the one or more patient data sources for each patient.

In another aspect of this embodiment, the risk condition is Venous Thromboembolism.

In yet another aspect of this embodiment, the risk condition is Deep Vein Thrombosis.

In another aspect of this embodiment, the risk condition is Pulmonary Embolism.

In another aspect of this embodiment, the set of risk factors includes two or more of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors includes the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors consists of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors have the following classifications: major risk factors: patient has been diagnosed with cancer, patient has had a prior occurrence of a Venous Thromboembolism, and patient has been diagnosed with hypercoagulability; intermediate risk factors: patient has had major surgery; and minor risk factors: patient has not had major surgery and is currently on bed rest; patient is of advanced age, patient is obese, and patient is receiving hormone replacement therapy or is currently using oral contraceptives.

In yet another aspect of this embodiment, the act of issuing an alert includes displaying the alert on a display device.

In another aspect of this embodiment, the act of issuing alert includes directing the alert to one or more appropriate health care providers.

One or more acts of the preceding embodiment and/or one or more aspects thereof may be implemented using a computer or other type of computational system.

Aspects of this embodiment of the invention include any suitable combination of the foregoing aspects and/or variations thereof.

In another embodiment of the invention, a system is provided for determining whether to issue an alert for consideration of prophylaxis for at least one patient with respect to a risk condition. The system includes a risk condition determination module to determine whether the at least one patient has the risk condition by determining, for each of a set of risk factors, each risk factor having a risk classification, whether the risk factor is satisfied for the at least one patient, and determining if one or more predefined combinations of risk factors are satisfied, based on the classifications of the satisfied risk factors. The system also includes an alert module to issue an alert to consider prophylaxis for the at least one patient if it is determined that the at least one patient has the risk condition.

In an aspect of this embodiment, the risk condition determination module is operable to determine whether the at least one patient has the risk condition by determining, for each of the set of risk factors, each risk factor being classified as a major risk factor, an intermediate risk factor or a minor risk factor, whether the risk factor is satisfied for the at least one patient, and determining if: at least one of the major risk factor is satisfied and at least one of an intermediate or minor risk factor is satisfied, or at least two intermediate risk factors are satisfied, or at least one major intermediate risk factor and at least two minor risk factors are satisfied, or at least four minor risk factors are satisfied.

In another aspect of this embodiment, the risk condition determination module includes means for determining whether the at least one patient has the risk condition.

In another aspect of this embodiment, each risk factor is classified as a major risk factor, an intermediate risk factor or a minor risk factor, and the alert module is operative to issue an alert to consider prophylaxis for the at least one patient if: at least one of the major risk factor is satisfied and at least one of an intermediate or minor risk factor is satisfied; or at least two intermediate risk factors are satisfied; or at least one major intermediate risk factor and at least two minor risk factors are satisfied; or at least four minor risk factors are satisfied.

In another aspect of this embodiment, the major risk factors have a pre-selected value=3, the intermediate factors have a pre-selected value=2 and the minor factors have a pre-selected value=1. In this aspect, the risk condition determination module is operative, for each satisfied risk factor for the at least one patient, to assign one of the pre-selected values to the risk factor based on the classification of the risk factor, and add the assigned values for the at least one patient to produce a risk score. In this aspect, the alert module is operative to issue the alert if the risk score is equal to or greater than 4.

In yet another aspect of this embodiment, the risk condition determination module is operative to determine whether the at least one patient has the risk condition for at least a subset of a patient population.

In another aspect of this embodiment, the risk condition determination module is operative to determine whether the at least one patient has the risk condition at a predetermined frequency, for example, daily.

In another aspect of this embodiment, the system includes a querying module to access one or more patient information data sources.

In another aspect of this embodiment, the risk condition determination module is operative to determine, for a plurality of patients, for each risk factor of a set of risk factors, whether the risk factor is satisfied by one or more of the plurality of patients. In this aspect, the querying module is operative to access information, on which the determination is based at least in part, from the one or more patient data sources for each patient.

In yet another aspect of this embodiment, the risk condition is Venous Thromboembolism.

In another aspect of this embodiment, the risk condition is Deep Vein Thrombosis.

In another aspect of this embodiment, the risk condition is Pulmonary Embolism.

In another aspect of this embodiment, the set of risk factors includes two or more of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In yet another aspect of this embodiment, the set of risk factors includes the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors consists of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors have the following classifications: major risk factors: patient has been diagnosed with cancer, patient has had a prior occurrence of a Venous Thromboembolism, and patient has been diagnosed with hypercoagulability; intermediate risk factors: patient has had major surgery; and minor risk factors: patient has not had major surgery and is currently on bed rest; patient is of advanced age, patient is obese, and patient is receiving hormone replacement therapy or is currently using oral contraceptives.

In another aspect of this embodiment, the alert module is operative to display the alert on a display device.

In another aspect of this embodiment, the alert module is operative to direct the alert to one or more appropriate health care providers.

Aspects of this embodiment of the invention include any suitable combination of the foregoing aspects and/or variations thereof.

In another embodiment of the invention, a computer program product is provided. The computer program product includes a computer-readable medium and computer-readable signals, stored on the computer-readable medium, that define instructions that, as a result of being executed by a computer, control the computer to perform a process of determining whether to issue an alert for consideration of prophylaxis for a patient with respect to a risk condition. The process including acts of: (A) for each of a set of risk factors, each risk factor having a risk classification, determining whether the risk factor is satisfied for the at least one patient; and (B) issuing an alert to consider prophylaxis for the at least one patient if one or more predefined combinations of risk factors are satisfied, based on the classifications of the satisfied risk factors.

In an aspect of this embodiment, each risk factor is classified as a major risk factor, an intermediate risk factor or a minor risk factor, and the act (B) includes issuing an alert to consider prophylaxis for the at least one patient if: at least one of the major risk factor is satisfied and at least one of an intermediate or minor risk factor is satisfied; or at least two intermediate risk factors are satisfied; or at least one major intermediate risk factor and at least two minor risk factors are satisfied; or at least four minor risk factors are satisfied.

In another aspect of this embodiment, the major risk factors have a pre-selected value=3, the intermediate factors have a pre-selected value=2 and the minor factors have a pre-selected value=1, the process further including acts of: (C) for each satisfied risk factor for the at least one patient, assigning one of the pre-selected values to the risk factor based on the classification of the risk factor; and (D) adding the assigned values for the at least one patient to produce a risk score. In this aspect, the act (B) includes issuing the alert if the risk score is equal to or greater than 4.

In another aspect of this embodiment, the act (A) is performed for at least a subset of a patient population.

In yet another aspect of this embodiment, the process further includes an act of: (C) repeating the acts (A) and (B) at a predetermined frequency.

In another aspect of this embodiment, the frequency is daily.

In an aspect of this embodiment, the act (A) includes accessing one or more patient information data sources.

In another aspect of this embodiment, the act (A) includes, for a plurality of patients, determining for each risk factor of a set of risk factors, whether the risk factor is satisfied by one or more of the plurality of patients by accessing information from the one or more patient data sources for each patient.

In another aspect of this embodiment, the risk condition is Venous Thromboembolism.

In another aspect of this embodiment, the risk condition is Deep Vein Thrombosis.

In yet another aspect of this embodiment, the risk condition is Pulmonary Embolism.

In another aspect of this embodiment, the set of risk factors includes two or more of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors includes the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors consists of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

In another aspect of this embodiment, the set of risk factors have the following classifications: major risk factors: patient has been diagnosed with cancer, patient has had a prior occurrence of a Venous Thromboembolism, and patient has been diagnosed with hypercoagulability; intermediate risk factors: patient has had major surgery; and minor risk factors: patient has not had major surgery and is currently on bed rest; patient is of advanced age, patient is obese, and patient is receiving hormone replacement therapy or is currently using oral contraceptives.

In yet another aspect of this embodiment, the act (B) includes displaying the alert on a display device.

In another aspect of this embodiment, the act (B) includes directing the alert to one or more appropriate health care providers.

Aspects of this embodiment of the invention include any suitable combination of the foregoing aspects and/or variations thereof.

In another embodiment of the invention, it is determined whether to prescribe prophylaxis for at least one patient with respect to a risk condition. A program is executed on a computer system to periodically query one or more data sources to retrieve patient information for the plurality of patients, to determine, based on the retrieved patient information, whether at least one of the plurality of patients has the risk condition, and to issuing an alert to consider prophylaxis for the at least one patient if it is determined that the at least one patient has the risk condition. An alert to consider prophylaxis for the at least one patient is received as a result of executing the program, and it is determined whether to prescribe prophylaxis for the at least one patient based at least in part on the alert.

In an aspect of this embodiment, prophylaxis is prescribed for the at least one patient in response to the alert.

In another aspect of this embodiment, executing the program includes querying one or more data sources at a predetermined frequency, for example, daily.

In another aspect of this embodiment, the risk condition is a risk of a Venous Thromboembolism.

In another aspect of this embodiment, the risk condition is a condition of a Deep Vein Thrombosis.

In another aspect of this embodiment, the risk condition is a condition of a Pulmonary Embolism.

In another aspect of this embodiment, executing the program and receiving the alert are performed independently of any event affecting the risk condition for the at least one patient.

In yet another aspect of this embodiment, executing the program and receiving the alert are performed independently of entering patient information into the one or more data sources.

In another aspect of this embodiment, patient information for a plurality of patients is entered into the one or more data sources.

In another aspect of this embodiment, receiving the alert includes receiving the alert on a display device.

In another aspect of this embodiment, the alert is received by an appropriate health care provider.

In yet another aspect of this embodiment, determining whether to prescribe prophylaxis is performed by an authorized health care provider.

Aspects of this embodiment of the invention include any suitable combination of the foregoing aspects and/or variations thereof.

In another embodiment of the invention, it is determined whether to issue an alert for consideration of prophylaxis for a plurality of patients with respect to a risk condition. Periodically, at a predefined frequency, one or more data sources are queried to retrieve patient information for the plurality of patients. Based on the retrieved patient information, it is determined whether at least one of the plurality of patients has the risk condition. If it is determined that the at least one patient has the risk condition, an alert to consider prophylaxis for the at least one patient is issued.

In an aspect of this embodiment, a time at which the one or more data sources are queried is independent of any event affecting the patient information from which it is determined whether the at least one patient has the risk condition.

In another aspect of this embodiment, a time at which the one or more data sources are queried is independent of entering of patient information into the one or more data sources.

In another aspect of this embodiment, the predetermined frequency is daily.

In another aspect of this embodiment, the risk condition is a risk of a Venous Thromboembolism.

In yet another aspect of this embodiment, the risk condition is a risk of a Deep Vein Thrombosis.

In another aspect of this embodiment, the risk condition is a risk of a Pulmonary Embolism.

In another aspect of this embodiment, prophylaxis is prescribed for the at least one patient in response to the alert.

In another aspect of this embodiment, the alert is displayed on a display device.

In another aspect of this embodiment, issuing the alert includes directing the alert to one or more appropriate health care providers.

One or more of the acts of this embodiment and/or one or more aspects thereof may implemented using a computer or other type of computational device.

Aspects of this embodiment of the invention include any suitable combination of the foregoing aspects and/or variations thereof.

In another embodiment of the invention, a system is provided for determining whether to issue an alert for consideration of prophylaxis for a plurality of patients with respect to a risk condition. The system includes a querying module to periodically query, at a predefined frequency, one or more data sources to retrieve patient information for the plurality of patients. The system also includes a risk condition determination module to determine, based on the retrieved patient information, whether at least one of the plurality of patients has the risk condition. The system further includes an alert module to issue an alert to consider prophylaxis for the at least one patient if it is determined that the at least one patient has the risk condition.

In another aspect of this embodiment, the risk condition determination module includes means for determining whether the at least one of the plurality of patients has the risk condition.

In another aspect of this embodiment, the a risk condition determination module is operative to make the determination at a time that is independent of any event affecting the patient information from which the determination is made.

In yet another aspect of this embodiment, the a risk condition determination module is operative to make the determination at a time that is independent of entering patient information into the one or more data sources.

In another aspect of this embodiment, the predetermined frequency is daily.

In another aspect of this embodiment, the risk condition is a risk of a Venous Thromboembolism.

In another aspect of this embodiment, the risk condition is a risk of a Deep Vein Thrombosis.

In yet another aspect of this embodiment, the risk condition is a risk of a Pulmonary Embolism.

In another aspect of this embodiment, the alert module is operative to display the alert on a display device.

In another aspect of this embodiment, the alert module is operative to direct the alert to one or more appropriate health care providers.

Aspects of this embodiment of the invention include any suitable combination of the foregoing aspects and/or variations thereof.

In another embodiment of the invention, a computer program product is provided. The computer program product includes a computer-readable medium and computer-readable signals, stored on the computer-readable medium, that define instructions that, as a result of being executed by a computer, control the computer to perform a process of determining whether to issue an alert for consideration of prophylaxis for a plurality of patients with respect to a risk condition. The process including acts of: (A) periodically, at a predefined frequency, querying one or more data sources to retrieve patient information for the plurality of patients, (B) determining, based on the retrieved patient information, whether at least one of the plurality of patients has the risk condition, and (C) if it is determined that the at least one patient has the risk condition, issuing an alert to consider prophylaxis for the at least one patient.

In an aspect of this embodiment, a respective time at which each performance of the act (A) is performed is independent of any event affecting the patient information from which it is determined whether the at least one patient has the risk condition.

In another aspect of this embodiment, a respective time at which each performance of the act (A) is performed is independent of entering of patient information into the one or more data sources.

In another aspect of this embodiment, the predetermined frequency is daily.

In another aspect of this embodiment, the risk condition is a risk of a Venous Thromboembolism.

In another aspect of this embodiment, the risk condition is a risk of a Deep Vein Thrombosis.

In another aspect of this embodiment, the risk condition is a risk of a Pulmonary Embolism.

In yet another aspect of this embodiment, the process further includes an act of: (D) prescribing prophylaxis for the at least one patient in response to the alert.

In another aspect of this embodiment, the act (C) includes displaying the alert on a display device.

In another aspect of this embodiment, the act (C) included directing the alert to one or more appropriate health care providers.

Aspects of this embodiment of the invention include any suitable combination of the foregoing aspects and/or variations thereof.

In another embodiment of the invention, it is determined whether to issue an alert for consideration of prophylaxis for one or more patients with respect to a risk condition. One or more data sources of patient information are queried to retrieve patient information for the plurality of patients, wherein a time at which the querying is performed is independent of any of the patient information being entered into the database. Based on the retrieved patient information, it is determined whether at least one of the plurality of patients has the risk condition, and, if it is determined that the at least one patient has the risk condition, an alert to consider prophylaxis for the at least one patient is issued.

In an aspect of this embodiment, a time at which the one or more data sources are queried is independent of any event affecting the patient information from which it is determined whether the at least one patient has the risk condition.

In another aspect of this embodiment, the one or more data sources are queried periodically, for example, daily.

In another aspect of this embodiment, the risk condition is a risk of a Venous Thromboembolism.

In yet another aspect of this embodiment, the risk condition is a risk of a Deep Vein Thrombosis.

In another aspect of this embodiment, the risk condition is a risk of a Pulmonary Embolism.

In another aspect of this embodiment, prophylaxis is prescribed for the at least one patient in response to the alert.

In another aspect of this embodiment, issuing the alert includes displaying the alert on a display device.

In another aspect of this embodiment, issuing the alert includes directing the alert to one or more appropriate health care providers.

One or more of the acts of this embodiment and/or one or more acts thereof may be implemented using a computer or other computational device.

Aspects of this embodiment of the invention include any suitable combination of the foregoing aspects and/or variations thereof.

In another embodiment of the invention, a system is provided for determining whether to issue an alert for consideration of prophylaxis for one or more patients with respect to a risk condition. The system includes a querying module to query one or more data sources to retrieve patient information for a selected set of patients, wherein a time at which the querying is performed is independent of any of the patient information being entered into the database. The system also includes a determination module to determine, based on the retrieved patient information, whether, for each patient in the set, the patient has the risk condition, and an alert module to issue an alert, if it is determined that the patient has the risk condition, to consider prophylaxis for the patient.

In an aspect of this embodiment, the risk condition determination module includes means for determining whether the at least one of the plurality of patients has the risk condition.

In another aspect of this embodiment, the determination module is operative to make the determination independent of any event affecting the patient information from which the determination is made.

In another aspect of this embodiment, the determination module is operative to make the determination periodically.

In another aspect of this embodiment, the determination module is operative to make the determination daily.

In another aspect of this embodiment, the risk condition is a risk of a Venous Thromboembolism.

In yet another aspect of this embodiment, the risk condition is a risk of a Deep Vein Thrombosis.

In another aspect of this embodiment, the risk condition is a risk of a Pulmonary Embolism.

In another aspect of this embodiment, the alert module is operative to display the alert on a display device.

In another aspect of this embodiment, the alert module is operative to direct the alert to one or more appropriate health care providers.

Aspects of this embodiment of the invention include any suitable combination of the foregoing aspects and/or variations thereof.

In another embodiment of the invention, a computer program product is provided. The computer program product includes a computer-readable medium and computer-readable signals, stored on the computer-readable medium, that define instructions that, as a result of being executed by a computer, control the computer to perform a process of determining whether to issue an alert for consideration of prophylaxis for one or more patients with respect to a risk condition. The process includes acts of: (A) querying one or more data sources of patient information to retrieve patient information for the plurality of patients, wherein a time at which the querying is performed is independent of any of the patient information being entered into the database, (B) determining, based on the retrieved patient information, whether at least one of the plurality of patients has the risk condition, and (C) if it is determined that the at least one patient has the risk condition, issuing an alert to consider prophylaxis for the at least one patient.

In an aspect of this embodiment, a respective time at which each performance of the act (A) is performed is independent of any event affecting the patient information from which it is determined whether the at least one patient has the risk condition.

In another aspect of this embodiment, the act (A) is performed periodically.

In another aspect of this embodiment, the act (A) is performed daily.

In yet another aspect of this embodiment, the risk condition is a risk of a Venous Thromboembolism.

In another aspect of this embodiment, the risk condition is a risk of a Deep Vein Thrombosis.

In another aspect of this embodiment, the risk condition is a risk of a Pulmonary Embolism.

In another aspect of this embodiment, the act (C) includes displaying the alert on a display device.

In yet another aspect of this embodiment, the act (C) includes directing the alert to one or more appropriate health care providers.

Advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures may be represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a block diagram illustrating an example of a network system for implementing embodiments of the invention;

FIG. 2 is a block and dataflow diagram illustrating an example of a system for determining whether to issue an alert for consideration of prophylaxis for a patient with respect to a risk condition;

FIG. 3 is a flow chart illustrating an example of a method of determining whether to issue an alert for consideration of prophylaxis for a plurality of patients with respect to a risk condition;

FIG. 4 is a flowchart illustrating an example of a method of determining, from retrieved patient information, whether one or more patients has a risk condition;

FIG. 5 is a flowchart illustrating an example of a method of determining whether a patient has a risk condition based on pre-selected values and/or classifications;

FIG. 6 is a flow chart illustrating another example of a method of determining whether a patient has a risk condition based on pre-selected values and/or classifications;

FIG. 7 is a flowchart illustrating an example of a method of issuing an alert to consider prophylaxis for a patient;

FIG. 8 is a flowchart illustrating an example of a method of determining whether to prescribe prophylaxis for a patient with respect to a risk condition; and

FIG. 9 illustrates Kaplan-Meier curves for freedom from DVT or PE in intervention (computer alert) and control (no computer alert) patients (log-rank p<0.001).

### DETAILED DESCRIPTION

Disclosed herein is a system and method for determining whether to issue an alert to consider prophylaxis (e.g., mechanical and/or pharmacological) with respect to a risk condition (e.g., risk of VTE, DVT and/or PE). One or more sources of patient information may be queried by a computer-implemented processor to retrieve patient information for a population to be screened, such as admitted in-patients (e.g., hospitalized patients). The one or more sources may be queried at a predefined frequency such as, for example, hourly, every few hours, twice a day, daily, bi-daily, weekly, bi-weekly, etc. Further, the time at which each query is performed may be independent of patient information being entered into the one or more data sources (e.g., upon admittance, post-surgery, etc.).

From the retrieved patient information, it may be determined by the processor, using algorithms discussed below, whether one or more risk factors of a set of risk factors are satisfied for each screen patient. For each patient for which one or more risk factors are satisfied, a respective value and/or classification is assigned to each risk factor. The values and/or classifications are combined to produce a combined value, and it is determined from the combined value whether the patient has the risk condition. If the patient has the risk condition, an alert is issued (e.g., on a display screen), to appropriate health care provider(s), for consideration of prophylaxis. As used herein, a “health care provider” is any of: a physician (e.g., osteopathic, medical, etc.), a nurse, a nurse practitioner, a physician's assistant, a therapist, another type of doctor or another recognized type of health care provider.

Upon consideration of the alert, an authorized health care provider (i.e., a health care provider with the authority to make such decisions) decides how to treat the patient based at least in part on the issued alert. For example, it may be decided to prescribe prophylaxis or other treatment in response to the alert.

As will be described in more detail below, the systems and method described herein have been observed to increase the use of prophylaxis (e.g., by physicians in prescribing treatment for patients), and may markedly reduce rates of occurrence of certain preventable events such as, for example, VTE, DVT and/or PE.

Although the systems and methods described herein are described primarily in relation to VTE, DVT and PE, the invention is not limited to these risk conditions. The systems and methods described herein may be used to determine other risk conditions (e.g., risk of heart attack or stroke) for patients and, in response, issue alerts to consider prophylaxis. Further, although the systems and methods described herein are described primarily in relation to issuing alerts to consider prophylaxis, the invention is not so limited. The systems and methods described herein may be used to take other actions and/or issue other types of alerts in response to determining a risk condition.

The function and advantage of these and other embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

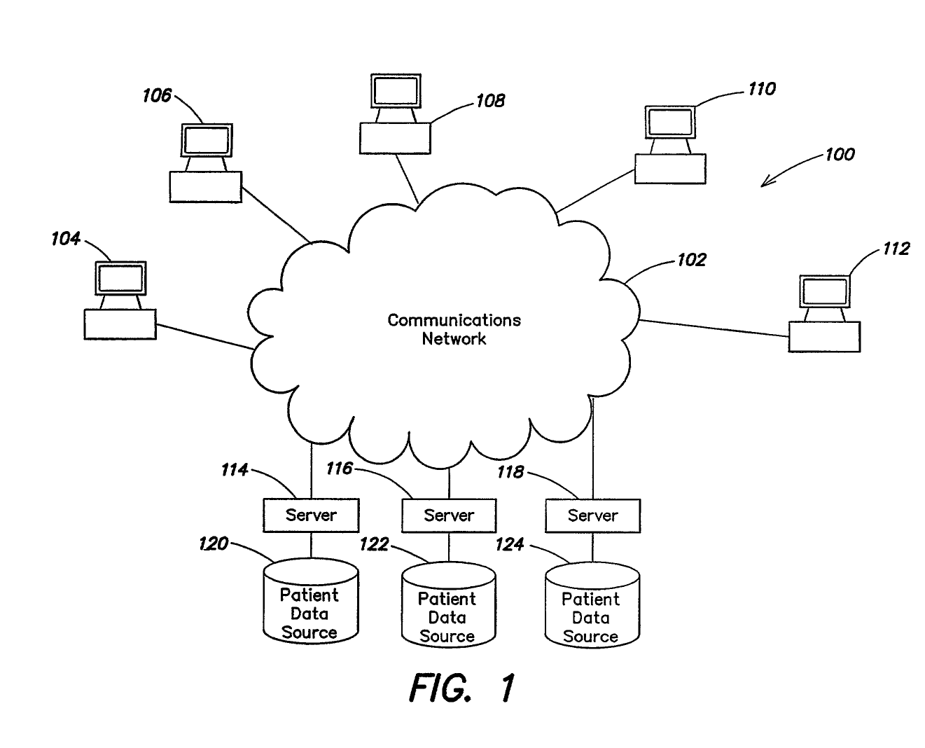

FIG. 1 is a block diagram illustrating a non-limiting example of a network system 100 for implementing embodiments of the invention. Network system 100 is merely an illustrative embodiment of such a system. Any of numerous other implementations of such a network system, for example, variations of network system 100, are possible, and are intended to fall within the scope of the invention.

Network system 100 may include any of communications network 102, user devices 104, 106, 108, 110 and 112, servers 114, 116 and 118, patient data sources 120, 122 and 124, and other components. As used herein, a “network” is a group of two or more components interconnected by one or more segments of transmission media on which communications may be exchanged between the components. Each segment may be any of a plurality of types of transmission media, including one or more electrical or optical wires or cables made of metal and/or optical fiber, air (e.g., using wireless transmission over carrier waves) or any combination of these transmission media. As used herein, “plurality” means two or more. It should be appreciated that a network may be as simple as two components connected by a single wire, bus, wireless connection or other type of segments. Further, it should be appreciated that when a network is illustrated in a drawing of this application as being connected to an element in the drawing, the connected element itself is considered part of the network.

It should be appreciated that all of the elements of system 100 may reside at a single location, for example, a single hospital, a single building, a single ward and/or a single floor, or two or more of the elements may reside at different locations such as, for example, different hospitals, different buildings, different wards and/or different floors.

Any of the user devices 104-112 may communicate with one or more of the servers 114, 116, 118 to write data to and read data from patient data sources 120, 122 and 124, which each may be any of a plurality of types of data sources, for example, a database (e.g., relational, object-oriented, file system or any suitable combination thereof). In some embodiments, the database is managed by a Caché database system available from Intersystems, Inc. of Cambridge, Mass. Each of servers 114, 116 and 118 may be any a plurality of types of data servers, for example, an Microsoft NT server. User devices may include any suitable input and/or output devices including without limitation, personal computers, workstations, personal digital assistants (PDAs), wireless phones, pagers and specialized terminals.

For example, a user at user device 104 may enter patient information into patient data source 120, through server 114, by exchanging communications with server 114 across communications network 102. Such information may be entered when a patient is admitted to a medical facility such as, for example, a hospital, a doctor's office, a clinic or any other type of medical facility. The information may be entered by keyboard, scanner, voice recognition systems or any other input mechanism or combination of mechanisms. Patient information also may be entered during or in response to other events, including but not limited to, surgery; a test such as an x-ray, an MRI or laboratory analysis; an examination; a procedure; completion of rounds; checking in on a patient; the end of a shift; any other event; or any suitable combination of the foregoing. Such information may be entered by a health care provider, a laboratory technician, a secretary, a receptionist or another agent of a medical facility.

The one or more data sources may include data sources from any of: one or more Admission/Discharge/Transfer (A/D/T) systems, one or more Laboratory Resulting Systems, one or more Order Entry (e.g., CPOE) systems, one or more systems that maintain surgery information, one or more systems that maintain patient demographic information, one or more systems that maintain patient vitals information, other systems and any suitable combination thereof. One or more of these data sources may store patient diagnostic information

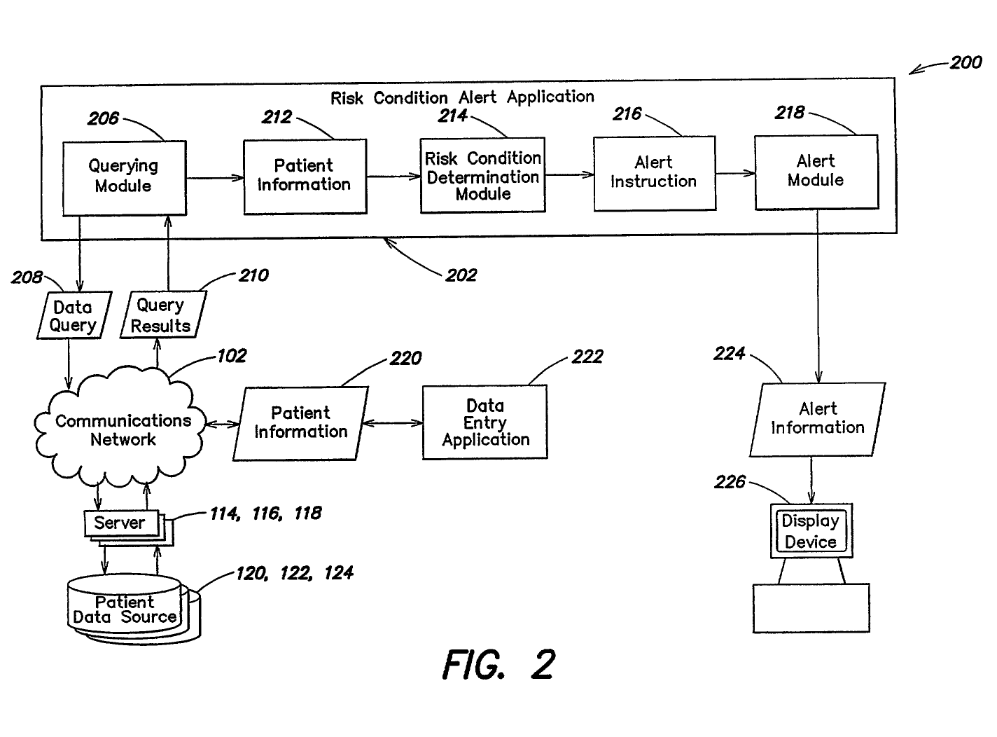

FIG. 2 is a block and dataflow diagram illustrating a non-limiting example of a system 200 for determining whether to issue an alert for consideration of prophylaxis for a patient with respect to a risk condition. System 200 is merely an illustrative embodiment of such a system, and is not intended to limit the scope of the invention. Any of numerous other implementations of such a system, for example, variations of system 200, are possible and are intended to fall within the scope of the invention.

System 200 may include any of: risk condition alert application 202; communications network 102; servers 114, 116 and 118; patient data sources 120, 122 and 124; data entry application 222; display device 226, and other elements. Data entry application 222 may be configured to enable a user to write data to and read data from one or more of the patient data sources. It should be appreciated that application 222 or a separate data entry module may be included in risk condition alert application 202.

Risk condition alert application 202 may include any of querying module 206, risk condition determination module 214 and alert module 218. Alert application 202 may be configured to determine whether one or more patients has one or more risk conditions. For example, a risk condition alert application may be configured to monitor one or more patient data sources (e.g., at a predetermined frequency) for a plurality of patients, to determine whether any patient is at risk of one or more conditions such as, for example, VTE, DVT, PE, heart attack, stroke, another risk condition, or any combination thereof. Further, an alert application may be configured to issue an alert (e.g., as a message on a display device, a sound, a call to a pager or telephone, an email, etc.) regarding a patient if it is determined that the patient is evaluated as having a particular risk condition.

An instance of a risk condition alert application 202 may reside on one or more of user devices 104, 106, 108, 110 and 112, and servers 114-118.

Querying module 206 may be configured to query one or more of the patient data sources 120, 122 and 124, for example, at a predetermined frequency (e.g., hourly, every few hours, twice a day, daily, bi-daily, weekly, biweekly, etc.). The frequency with which the querying module queries the one or more patient data sources may be chosen to balance the benefits of receiving the most current patient information against the detriment of increased system resource consumption.

Querying module 206 may be configured to send data query 208 to one or more of servers 114, 116 and 118 across communications network 102, and receive query results 210. Patient information 212 may be gleaned from the query results 210 and sent from module 206 to risk condition determination module 214. Querying module 206 may be configured to query patient data sources 120, 122 and 124 for patient information 212 that may be useful in determining whether one or more patients has a risk condition. As used herein, “has a risk condition” means that, applying a predetermined screening algorithm, the patient is evaluated to be considered at risk for a particular condition. Risk condition determination module 214 may be configured to receive patient information 212 and provide an alert instruction for one or more patients if it determines that the one or more patients have the risk condition.

If risk condition determination module 214 determines that a patient has a risk condition, the module may send alert instruction 216 to alert module 218, in response to which the alert module 218 may send alert information 224 to display device 226. Module 214 may be configured to determine the person to whom the alert should be sent. For example, the retrieved patient information may indicate the one or more health care providers responsible for each patient, and/or the working schedules of the health care providers. Risk condition determination module 214 may be configured to use this information and, in addition to determining that a patient is at risk, determine to whom an alert should be sent.

Although the alert information 224 is shown as being transmitted directly from alert module 218 to display device 226, the invention is not so limited. Alert module 218 may be configured to transmit alert information to one or more other locations and/or devices. For example, the alert module may be operative to transmit alert information to one or more devices (e.g. a computer, PDA, telephone, pager, etc.) across a communications network (e.g., network 102). Further, the alert information may include alert information other than textual information to display oil a screen such as, for example, sound, shapes, color and light, or any suitable combination of the foregoing.

Determination module 214 may be configured to determine, for each patient for which patient information 212 is provided, whether one or more risk factors of a set of risk factors are present for the patient. The risk factors included in the set of risk factors may be selected depending on the one or more risk conditions for which a determination is being made. For example, the set of risk factors may include (and may be limited to) whether: the patient has been diagnosed with cancer; the patient has had a prior occurrence of VTE; the patient has been diagnosed with hypercoagulability; the patient has had major surgery; the patient has not had major surgery and is currently on bed rest; the patient is of advanced age; the patient is obese; and the patient is receiving hormone replacement therapy or is currently using oral contraceptives. Such a set of risk factors may be used to determine if a patient is at risk of VTE, DVT, PE, other conditions, or any suitable combination of the foregoing.

The risk condition determination module 214 may be configured with one or more definitions of sets of risk factors (e.g., the set described above), depending upon the risk conditions that the module is configured to determine. The determination module 214 also may be configured with a value and/or classification for each risk factor of the set. For example, the set of risk factors may be divided into a plurality of classifications, for example, major risk factors, intermediate risk factors and minor risk factors. It should be appreciated that other classifications may be used, and module 214 may be configured with definitions of these classifications. Alternatively, or in addition to classifying the risk factors, a value may be selected for each risk factor. These selected values may correlate to the classification of the risk factor.

In some embodiments, for example, the following risk factors may have the following selected values: the patient has been diagnosed with cancer=3; the patient has had a prior occurrence of VTE=3; the patient has been diagnosed with hypercoagulability=3; the patient has had major surgery=2; the patient has not had major surgery and is currently on bed rest=1; the patient is of advanced age=1; the patient is obese=1; and the patient is receiving hormone replacement therapy or uses oral contraceptives=1. It should be appreciated the other risk factor values may be used, and module 214 may be configured accordingly.

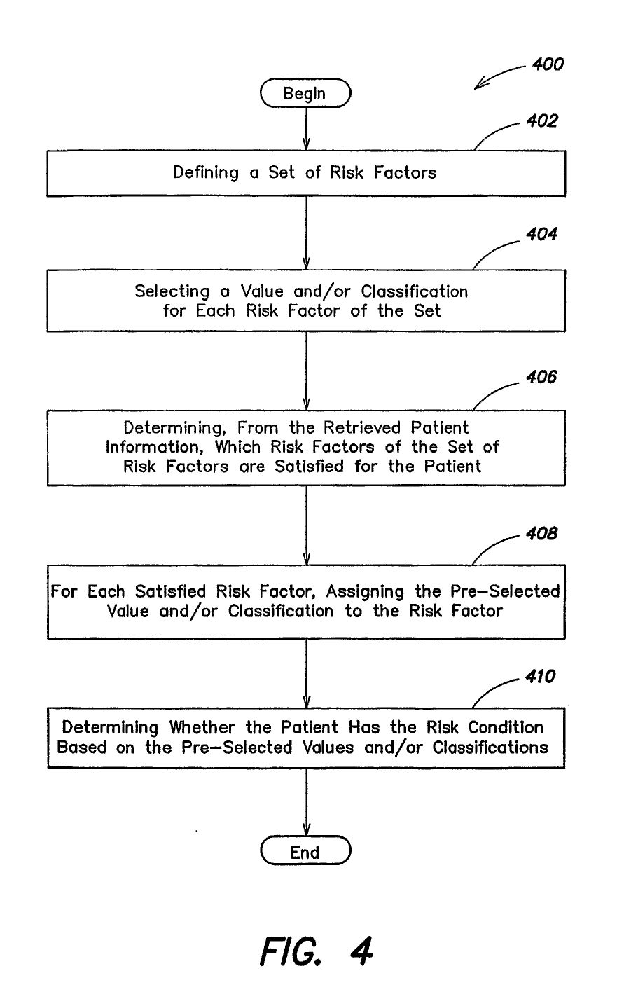

The risk condition determination module 214 may be configured to assign a pre-selected value and/or classification to each risk factor. Based on the pre-selected values and/or classifications, module 214 may execute a predetermined algorithm to determine whether the patient should be classified as having the risk condition. Module 214 may be configured to perform any of methods 400, 500 or 600, for example, to determine whether one or more patients have a risk condition, as is described in more detail below in relation to FIGS. 4-6.

Each of systems 100 and 200, and components thereof may be implemented using software (e.g., C, C#, C++, Java, M, Caché or a combination thereof), hardware (e.g., one or more application-specific integrated circuits), firmware (e.g., electrically-programmed memory) or any combination thereof. One or more of the components of system 100 and/or 200 (e.g., 206, 214, 218 and/or 220) may reside on a single device (e.g., a computer), or one or more components may reside on separate, discrete devices. Further, each component may be distributed across multiple devices, and one or more of the devices may be interconnected.

Further, on each of the one or more devices on which reside one or more components of system 100 and/or 200, each of the components may reside in one or more locations on the system. For example, different portions of the components of system 100 and/or 200 may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components.

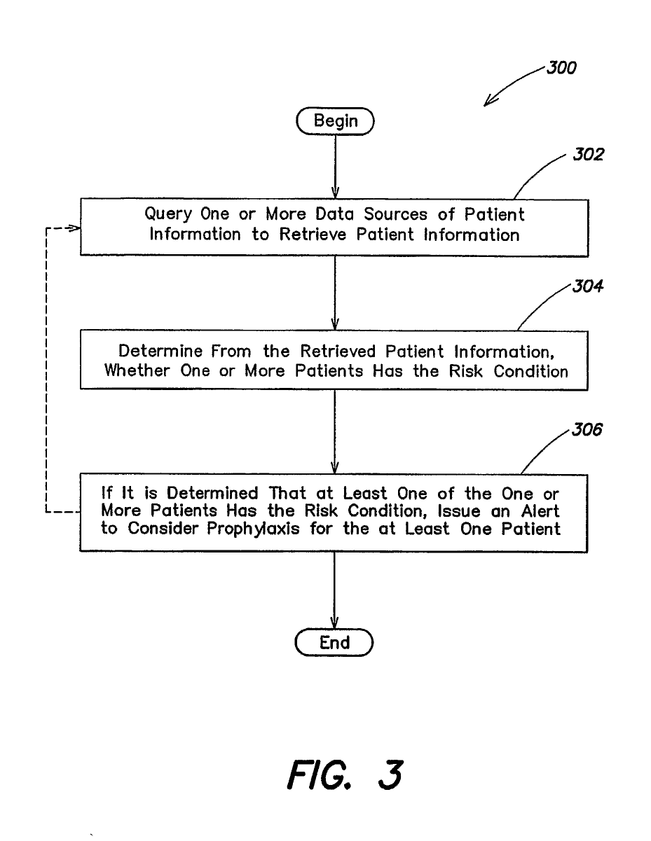

FIG. 3 is a flow chart illustrating a non-limiting example of a method 300 of determining whether to issue an alert for consideration of prophylaxis for a plurality of patients with respect to a risk condition. Method 300 is merely an illustrative embodiment of such a method. Any of numerous other implementations of such a method, for example, variations of method 300, are possible, and are intended to fall within the scope of the invention. Method 300 may include additional acts. Further, the order of the acts performed as part of method 300 is not limited to the order illustrated in FIG. 3, as the acts may be performed in other orders and/or one or more of the acts may be performed in series or in parallel (at least partially). For example, any of Acts 302, 304 and 306 (described below) may be performed for one patient concurrently to (or at different times from) any of these acts being performed for another patient.

In Act 302, one or more data sources (e.g., any of data sources 120, 122 and 124) may be queried to retrieve patient information, for example, as described above in relation to system 200. The data sources may be queried for all patients for whom information is stored on one or more data sources, or may be queried for less than all patients. For example, a specific sub-set of patients satisfying one or more criteria may be queried such as, for example, all patients currently admitted at a health care facility (e.g., hospital) or all patients in a particular health care unit (e.g., ER or OR), or all patients satisfying particular demographic criteria.

In Act 304, it may be determined, from the retrieved patient information, whether one or more patients has a risk condition. Although not illustrated in FIG. 3, Act 300 may include, for each patient determined to have the risk condition, determining whether the patient is already undergoing prophylaxis. This may be done by checking the retrieved patient information (e.g., the medical order records for the patient). If it is determined that the patient is already undergoing prophylaxis, then method 300 may not proceed to Act 306, but may return to Act 302 after a predetermined amount of time. If it is determined that the patient is not already undergoing prophylaxis, then the method may proceed to Act 306.

In Act 306, if it is determined that a patient has the risk condition, an alert may be issued to consider prophylaxis for the patient. As discussed above, method 300 may be performed periodically, such that after performance of Act 306, method 300 may return to Act 302 (e.g., after a predetermined amount of time).

Although not illustrated in FIG. 3, method 300 (e.g., as part of Act 304 or 306, or as a separate act) may include determining the person to whom the alert should be sent. For example, the patient information retrieved from the one or more data sources may include information including the one or more health care providers responsible for each patient and/or the working schedules of the health care providers. Accordingly, upon determining that a patient is at a risk, method 300 may include determining to whom to send the alert.

FIG. 4 is a flowchart illustrating a non-limiting example of a method 400 of determining, from retrieved patient information, whether a particular patient or any one of a group of patients has a risk condition, for example, as part of performing Act 304 of method 300. Method 400 is merely an illustrative embodiment of a method of determining whether a patient has a risk condition, and is not intended to limit the scope of the invention. Any of numerous other implementations of such a method, for example, variations of method 400, are possible and are intended to fall within the scope of the invention. Method 400 may include additional acts. Further, the order of the acts performed as part of method 400 is not limited to the order illustrated in FIG. 4, as the acts may be performed in other orders and/or one or more of the acts may be performed in series or in parallel (at least partially).

In Act 402, a set of risk factors (e.g., a set of risk factors described above in relation to system 200) may be defined, and in Act 404, a respective value and/or classification (e.g., any of the values and classifications described above in relation to system 200) may be selected for each risk factor of the set.

It should be appreciated that either of Acts 402 and 404 may be performed before the performance of Act 302. For example, set of risk factors and their respective values and/or classifications may be set and stored on a computer readable medium, and/or a computational module (e.g., risk condition determination module 214 of system 200) may be configured with such risk factor sets, values and/or classifications.

The following Acts 406-410 may be performed for each patient for which information was retrieved.

In Act 406, it may be determined, from the retrieved patient information, which risk factors of the set of risk factors are satisfied for the patient. For example, values of parameters included within the patient information may be compared to the risk factors of a set of risk factors to determine if there are any matches.

In Act 408, for each satisfied risk factor, the pre-selected value and/or classification (e.g., selected in Act 404) may be assigned to the risk factor. For example, if it is determined that a patient has been diagnosed with cancer and is obese, then the value of 3 may be assigned to the cancer risk factor and the value of 1 may be assigned to the obesity risk factor.

In Act 410, it may be determined whether the patient has the risk condition based on the pre-selected values and/or classifications. For example, such determination may be made by performance of method 500 and/or method 600.

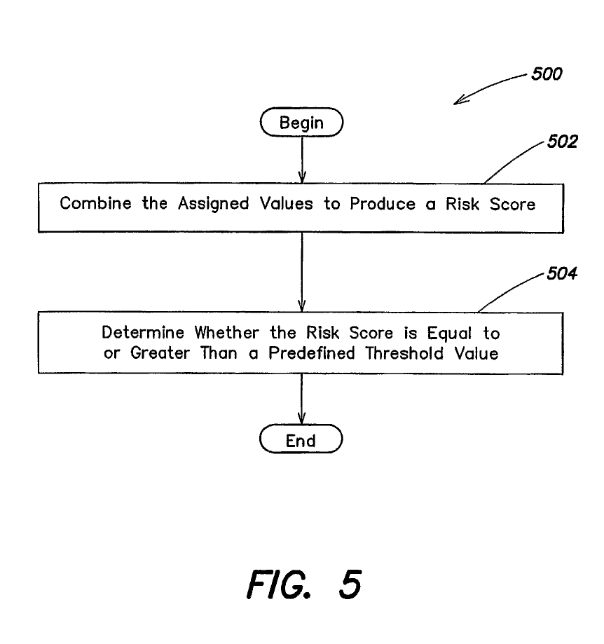

FIG. 5 is a flowchart illustrating a non-limiting example of a method 500 of determining whether a patient has a risk condition based on pre-selected values and/or classifications, for example, as part of Act 410 of method 400.

In Act 502, values assigned to risk factors are combined (e.g., added or averaged) to produce a risk score. For example, using the values provided as examples with respect to system 200, if the assigned values are 3 (the patient has had a prior occurrence of VTE) and 1 (the patient is of an advanced age), then the risk score may be 3+1=4. Alternatively, if the assigned values are 1 (the patient is obese) and 1 (the patient is receiving hormone replacement therapy or uses oral contraceptives), then the produced score may be 1+1=2.

In a following act, it may be determined whether the risk score satisfies one or more predefined criteria. For example, Act 504, it may be determined whether the risk score is equal to or greater than a predefined threshold value. Using the risk score from the first example of Act 502 4, if the predefined threshold value=4, then Act 504 returns a positive result. That is, it is determined that the patient has the risk condition. Using the second example of Act 502 (risk score=2), if the predefined threshold value=4, then Act 504 produces a negative result. That is, the patient is determined not to have the risk condition.

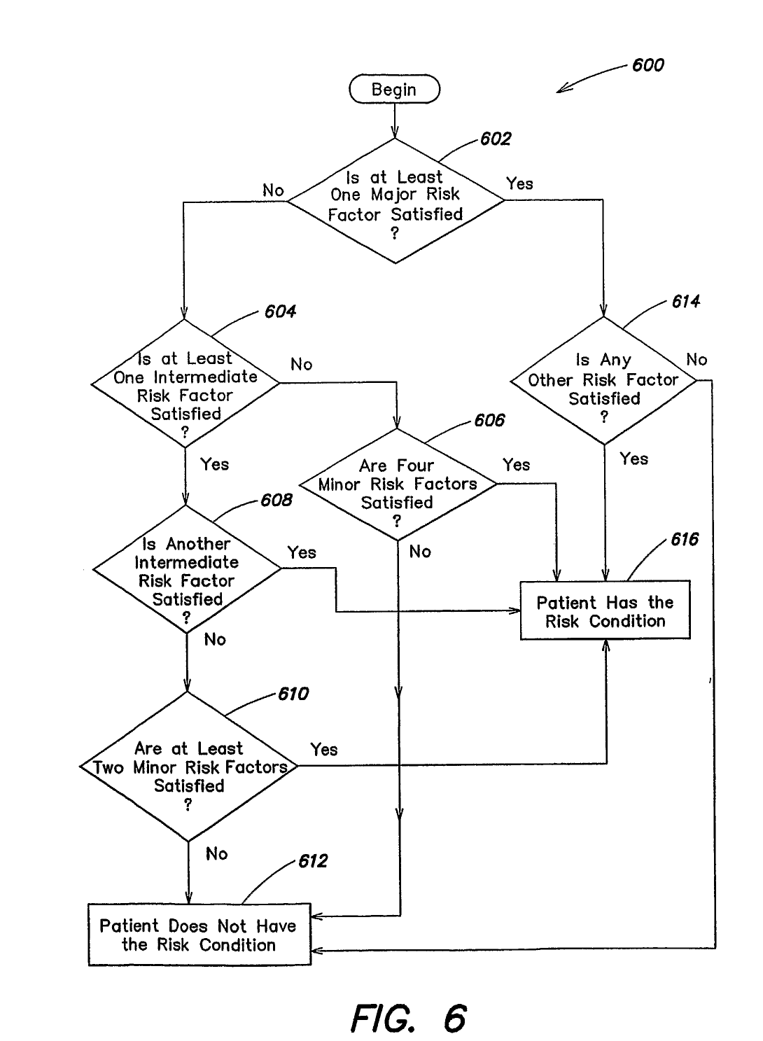

FIG. 6 is a flow chart illustrating another example of a method 600 of determining whether a patient has a risk condition based on pre-selected values and/or classifications, for example, as part of performing Act 410 of method 400. Method 600 is merely an a illustrative embodiment of a method of determining whether a patient has a risk condition based on pre-selected values and/or classifications, and is not intended to limit the scope of the invention. Any of numerous other implementations of such a method, for example, variations of method 600, are possible and are intended to fall within the scope of the invention. Method 600 may include additional acts. Further, the order of the acts performed as part of method 600 is not limited to the order illustrated in FIG. 6, as the acts may be performed in other orders and/or one or more of the acts may be performed in series or in parallel (at least partially).

Method 600 may include determining whether certain combinations of risk factors have been satisfied, e.g., based on the risk classifications of the satisfied risk factors. For example, based on the risk classifications of the satisfied risk factors, it may be determined whether there are particular combinations of classifications. In some embodiments, risk factors may be classified into three groups: major risk factors, intermediate risk factors, and minor risk factors. In such embodiments, method 600 may include determining that the risk condition is satisfied if: a) at least one of a major risk factor is satisfied and at least one of an intermediate or minor risk factor is satisfied; b) at least two intermediate risk factors are satisfied; c) at least one major intermediate risk factor and at least two minor risk factors are satisfied; or d) at least four minor risk factors are satisfied.

In Act 602, it may be determined whether at least one major risk factor (e.g., the patient has: been diagnosed with cancer; has had a prior occurrence of VTE; or has been diagnosed with hypercoagulability) is satisfied. If yes, then in Act 614, it may be determined whether any other risk factor is satisfied. If not, then it may be concluded that the patient does not have the risk condition; otherwise, it may be concluded that the patient has the risk condition.

Returning to Act 602, if it is determined that at least one major risk factor is not satisfied, then in Act 604 it may be determined whether at least one intermediate risk factor (e.g., the patient has had major surgery) is satisfied. If not, then it may be determined in Act 606 whether four minor risk factors (e.g., the patient: has not had major surgery and is currently on bed rest; the patient is of advanced age; the patient is obese; or the patient is receiving hormone replacement therapy or is currently using oral contraceptives) are satisfied. If not, it may be concluded that the patient does not have the risk condition (Act 612); otherwise, it may be concluded that the patient has the risk condition.

Returning to Act 604, if it is determined that at least one intermediate risk factor is satisfied, then in Act 608, it may be determined whether another intermediate risk factor is satisfied. If affirmative, then it may be concluded that the patient has the risk condition (Act 616). If negative, it may be determined whether there are at least two minor risk factors satisfied in Act 610, If affirmative, then it may be concluded that the patient has the risk condition; otherwise, it may be determined that the patient does not have the risk condition.

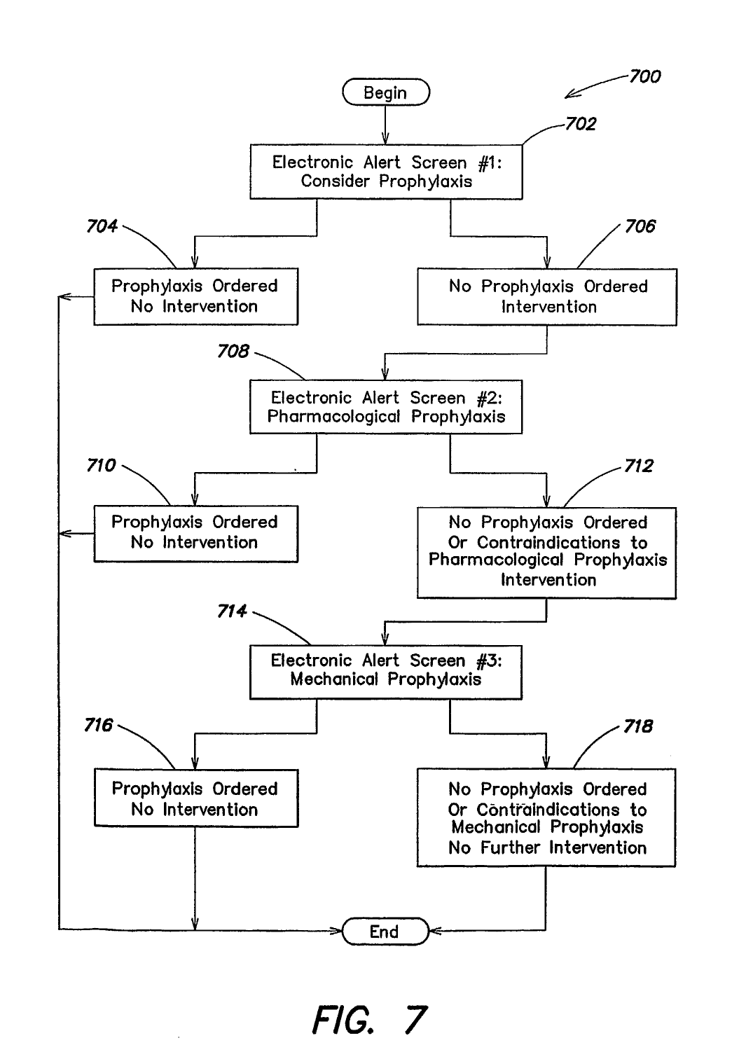

FIG. 7 is a flowchart illustrating a non-limiting example of a method 700 of issuing an alert to consider prophylaxis for a patient Method 700 is merely an illustrative embodiment of a method of issuing an alert to consider prophylaxis for a patient, and is not intended to limit the scope of the invention. Any of numerous other implementations of such a method, for example, variations of method 700, are possible and are intended to fall within the scope of the invention. Method 700 may include additional acts. Further, the order of the acts performed as pan of method 700 is not limited to the order illustrated in FIG. 7, as the acts may be performed in other orders and/or one or more of the acts may be performed in series or in parallel (at least partially). For example, Act 714 may be performed before or in parallel to Act 708.

In Act 702, a first electronic alert screen (e.g., of a computer) may issue an alert to condition prophylaxis. In response, a user may enter or select information indicating that prophylaxis has already been ordered in Act 704, and in response, method 700 may not intervene any further.

Alternatively, in Act 706, a user may refrain from entering or selecting information indicating that the prophylaxis is ordered or indicate that no prophylaxis has been ordered. It should be appreciated that the alert may include one or more different types of alerts such as, for example, displaying a message, playing a sound, flashing a display, etc. Further, the alert may be delivered to one or more locations such as, for example, a computer screen, a pager, a cellphone, a PDA, to a computer via e-mail to be displayed on a screen, etc. In response to a lack of entering/selecting prophylaxis information or entering that no prophylaxis has been ordered, method 700 may further intervene by proceeding to Act 708.

In Act 708, a second alert screen may be displayed requesting that pharmacological prophylaxis be considered. In response, a user may enter or select information indicating that prophylaxis has been ordered in Act 710 such that method 700 does not need to intervene any further. Alternatively, in Act 712, it may be determined that: the user did not indicate that any prophylaxis had been ordered; the user explicitly indicated that no prophylaxis has been ordered; or the user indicated disagreement with the recommendation of a pharmacological prophylaxis. In such a case, method 700 may determine that further intervention is required and proceed to Act 714.

In Act 714, a third screen may be displayed requesting that mechanical prophylaxis be considered. In Act 716, it may be determined that prophylaxis has been ordered. Alternatively, it may be determined, in Act 718, that the user either explicitly or implicitly did not order prophylaxis or that the user indicated disagreement with the recommendation for mechanical prophylaxis. In either scenario, method 700 may end.

It should be appreciated that Acts, 702, 708 and 714 are not limited to displaying information on separate screens. In some embodiments, two or more of these Acts may be performed by displaying information on a same screen. Such information may be displayed at different times in response to user actions, or may be displayed simultaneously, for example, with different information grayed out and/or highlighted based on user actions and/or navigation of the displayed information.

A health care provider or other personnel of a medical facility may utilize any of systems 100 and 200 and methods 300, 400, 500, 600 and 700 to determine whether to prescribe prophylaxis for a patient with respect to a risk condition, for example, as described in relation to method 800.

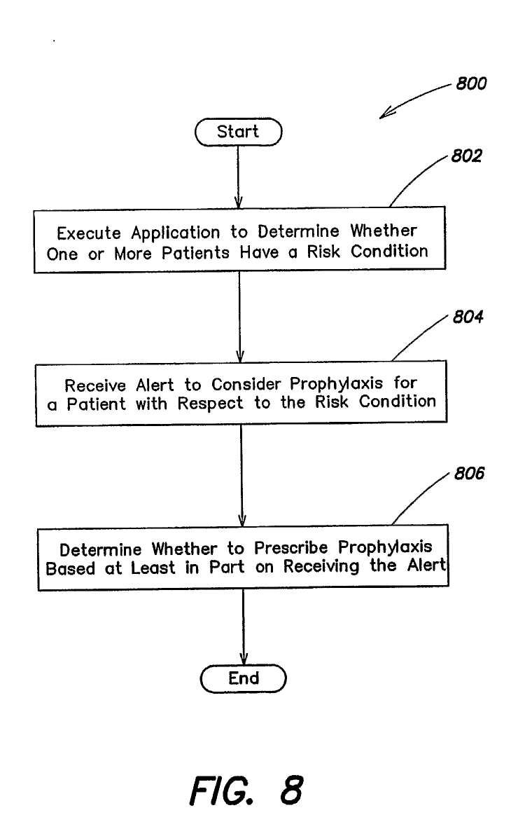

FIG. 8 is a flowchart illustrating a non-limiting example of a method 800 of determining whether to prescribe prophylaxis for a patient with respect to a risk condition. Method 800 is merely an illustrative embodiment of a method of determining whether to prescribe prophylaxis for a patient with respect to a risk condition, and is not intended to limit the scope of the invention. Any of numerous other implementations of such a method, for example, variations of method 800, are possible and are intended to fall within the scope of the invention. Method 800 may include additional acts. Further, the order of the acts performed as part of method 800 is not limited to the order illustrated in FIG. 8, as the acts may be performed in other orders and/or one or more of the acts may be performed in series or in parallel (at least partially). For example, Act 802 may continue to be performed during the performance of Act 804.

In Act 802, an application may be executed to determine whether one or more patients have a risk condition. Act 802 may include performing any of methods 300, 400, 500, or 600 or any suitable combination thereof, for example, on system 100, 200 or any suitable combination thereof.

In Act 804, an alert may be received (e.g., as a result of performance of Act 306 and/or method 700) to consider prophylaxis for a patient with respect to the risk condition. For example, as described above, health care provider responsible and on duty for the patient may be alerted (e.g., by e-mail, by pager, by telephone, by sound, etc.) to consider prophylaxis.

In Act 806, it may be determined (e.g., by an authorized health care provider) whether to prescribe prophylaxis for the patient based at least in part on receiving the alert. For example, an authorized health care provider may prescribe prophylaxis (e.g., mechanical or pharmacological prophylaxis) to the patient in response to receiving the alert. Alternatively, the authorized health care provider may prescribe another form of treatment for the patient, such as, for example, exercise or a change in diet. Further, the authorized health care provider may decide to do nothing. However, even in the situation where the authorized provider decides to do nothing, the alert may have at least raised the provider's awareness that a patient is at risk. Thus, even though the authorized health care provider may not do anything immediately in response to the alert, later the provider may behave differently knowing, or having been reminded, that a patient was determined to have a risk condition.

Each of methods 300, 400, 500, 600, 700 and 800, acts thereof and various embodiments and variations of these methods and acts, individually or in combination, may be defined by computer-readable signals tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., any of methods 300-800 and/or acts thereof), and/or various embodiments, variations and combinations thereof. Such instructions may be written in any of a plurality of programming languages, for example, Java, Visual Basic, C, C#, or C++, M, Caché, Fortran, Pascal, Eiffel, Basic, COBOL, etc., or any of a variety of combinations thereof. The computer-readable media on which such instructions are embodied may reside on one or more of the components of any of systems 100 and 200 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, embodiments of systems 100 and 200 described in relation to FIGS. 1 and 2, that perform the functions described herein can be generically considered as one or more processors or controllers that control such functions. The one or more processors or controllers can be implemented in numerous ways, such as with dedicated hardware and/or firmware, using one or more microprocessors and/or microcontrollers programmed using microcode or software to perform the functions recited above or any suitable combination of the foregoing.

### EXAMPLE

One example of a system and method for determining whether a patient is a risk of VTE, DVT or PE, and issuing an alert to consider prophylaxis will now be described. It should be appreciated that the invention is not limited to this example.

As a quality improvement initiative for the utilization of VTE prophylaxis, a randomized controlled trial of 2,506 hospitalized patients was undertaken to test a strategy of issuing or withholding electronic alerts to physicians whose patients were not receiving prophylaxis against DVT.

### Methods

### Study Design

We developed a computer program for identifying consecutive hospitalized patients at increased risk for VTE (M.P.; B.S.). The program was linked to the patient database of the hospital.

For over three years, we included hospitalized patients from medical and surgical services ≧18 years of age who were at increased risk for VTE. All patients from the Neurology Department, Newborn Service, and the Neonatal Intensive Care Unit were excluded as well as any patient receiving mechanical or pharmacological prophylaxis.

### Identification of Patients at Risk for Venous Thromboembolism

The computer program scored the VTE risk profile of each hospitalized patient using eight common risk factors. Each risk factor was weighted according to a point scale: cancer 3, prior VTE 3, hypercoagulability 3, major surgery 2, no major surgery and bed rest 1, advanced age 1, obesity 1, and hormone replacement therapy/oral contraceptives 1 score point(s). Increased VTE risk was defined as a cumulative VTE risk score ≧4, so that patients with at least one major risk factor (cancer, prior VTE, or hypercoagulability) plus at least one additional intermediate risk factor (major surgery) or minor risk factor (no major surgery and bed rest, advanced age, obesity, or hormone replacement therapy/oral contraceptives) became eligible. In the absence of a major risk factor, patients with one intermediate risk factor plus at least two minor risk factors became eligible. Daily screening of the computer alert program permitted patients to become eligible if they initially had a VTE risk score <4 but increased the score during hospitalization to ≧4.

The program identified patients with cancer using current inpatient problem lists by searching for the following cancer types: cervical, colon, lung, ovarian, prostate, rectal, renal, thyroid, uterine, pancreatic, liver, stomach, brain, esophageal, head and neck cancer, sarcoma, and melanoma. In addition, the admitting diagnoses were screened for cancer ICD 9 code ranges 149.0 to 172.99 and 174.0 to 209.99.

Inpatient and outpatient records were investigated for a personal history of DVT or PE. In addition, these ICD 9 codes were checked to screen for prior VTE: 415.1, 415.19, 453.8, 453.9, and 671.30 to 671.54.

For identification of hypercoagulable states, the database was searched for laboratory test results, including Factor V Leiden, lupus anticoagulant, and anticardiolipin antibodies. Major surgery was defined as any surgery lasting >60 minutes. The use of “bed rest” required an active bed rest order not related to surgery. Advanced age was defined as age >70 years. If weight and height data were available, the program calculated the body mass index (BMI). Obesity was defined as BMI >29 kg/m. If no weight and height data were available, inpatient and outpatient records were screened for the diagnosis of obesity. In addition, the ICD 9 code for obesity (278.0) was checked. Ongoing hormone replacement therapy or use of oral contraceptives was identified by screening active medications.

### Screening for Venous Thromboembolism Prophylaxis

If the cumulative VTE risk score was ≧4, the computer program reviewed orders to detect ongoing mechanical or pharmacological prophylactic measures. Electronic orders were searched for mechanical prophylactic measures that included graduated compression stockings and intermittent pneumatic compression boots. Active medications were screened for the presence of pharmacological prophylactic measures, including unfractionated heparin, enoxaparin, dalteparin, danaparoid, hirudin, and warfarin. Among 13,922 patients with a VTE risk score ≧4, 11,416 (79.1%) received and 2,506 (20.9%) did not receive mechanical or pharmacological prophylaxis a priori.

### Randomization and Electronic Alerts

The computer program randomized 2,506 eligible patients to either an intervention group (N=1,55) alerting the responsible physician only once or a control group (N=1,251) without an alert. Patients with even medical record numbers were assigned to the intervention group, and those with odd medical record numbers to the control group without further stratification.

The physician was forced to acknowledge the computer alert and could then withhold prophylaxis or, on the same computer screen, could order prophylaxis with options that included graduated compression stockings, intermittent pneumatic compression boots, unfractionated heparin, low molecular weight heparin, or warfarin. In addition, the computer alert screen was linked to the hospital's VTE prevention guidelines, providing drug dose regimens for the different indications according to published consensus guidelines. For control patients, VTE prevention guidelines were also available, but no specific prompt was provided to use them.

Overall, 120 physicians were responsible for the study patients: 104 physicians were assigned to a median of 12 (range 2-19) intervention patients, 102 physicians to a median of 13 (range 2-18) control patients. Thirty-four (28%) physicians were assigned to either intervention (18 physicians) or control patients (16 physicians) only. Physicians responsible for control group patients were not aware that these patients were followed for clinical events.

### Follow-Up

Ninety-day follow-up was performed in all study patients by medical record review using the patient database of the hospital. Clinical events were identified using information from the index hospitalization, recurrent hospitalizations, and office visits, including discharge summaries, physician notes, blood test results, vascular laboratory reports, nuclear medicine reports, or radiology reports. In addition, the Social Security Death Index was used to identify patients who died during 90 days.

Overall, 2,361 (94.2%) patients had follow-up data beyond the index hospitalization, and 145 (5.8%) patients were lost to follow-up. Among patients lost to follow-up, 78 were intervention and 67 were control patients (p=0.39). There were 2,007 (80.1%) patients with outpatient visits; 1,008 (40.2%) were rehospitalized during 90 days after randomization.

### Data Collection and Study Endpoints

The primary endpoint was clinically diagnosed DVT or PE at 90 days. In patients with more than 1 event, only the first event was counted. Safety endpoints included total mortality and hemorrhagic events at 30 and 90 days, respectively. We defined major bleeding as intracranial, intraocular, retroperitoneal, pericardial, or bleeding that required surgical intervention or that resulted in a hemoglobin loss greater than 3 g/l.

DVT was diagnosed if there was loss of vein compressibility by ultrasound or a filling defect by conventional contrast venography. PE was diagnosed in the presence of a high-probability ventilation perfusion scan, a positive contrast chest computed tomogram, or conventional pulmonary angiogram. Clinically suspected VTE events without objective confirmation of the diagnosis were not counted. Three investigators adjudicated all endpoints, blinded to group assignment.

### Statistical Analysis

The initial sample size (power 90%, two-sided alpha 5%) was calculated at 1,400 patients based on an estimated 50% VTE prophylaxis administration rate in the intervention group, a 10% rate of the primary end point in the control group, and an odds ratio of 0.50 for the primary endpoint in intervention group patients. After 700 patients were enrolled, the protocol was modified with an increase in sample size to 2,500 patients because of a lower than expected VTE prophylaxis rate in the intervention group. At the time of protocol modification, clinical endpoint data were not yet obtained. An interim analysis of efficacy and safety was undertaken after approximately half of the expected information was available. This analysis indicated that the predefined boundaries for early stopping were not crossed, based on the O'Brien-Fleming spending function according to the method of Lan and DeMets.

We used Wilcoxon rank-sum tests for comparisons in the distributions of continuous variables between groups, and χ² tests or Fisher's exact test for comparisons of categorical variables. The primary analysis was performed using Greenwood's formula for the difference in the Kaplan-Meier estimator for freedom from VTE at day 90 between intervention and control patients. The log-rank test was used to estimate the cumulative probability of the primary endpoint in the intervention and control groups.

We used the proportional-hazards model for estimation of the relative hazard of clinical endpoints associated with the computer alert and obtained confidence intervals from this model. The proportional-hazards model was also used to evaluate the effect of the computer alert on the primary endpoint in clinically important subgroups. In addition, we assessed the effect of the computer alert in subgroups by including a term for the interaction between group assignment and each clinical factor. All p-values reported are two-sided.

### Results

### Patient Characteristics

The intervention and control groups were well balanced with respect to the baseline characteristics (Table 1 below). Overall, there were 52.9% women and 47.1%

TABLE 1
Baseline Characteristics of the Study Participants

| | |
|---|---|
| Intervention | Control |
| N = 1255 | N = 1251 |

| | | | | |
|---|---|---|---|---|
| Women | 672 | (53.5) | 654 | (52.3) |
| Age, median (range) | 63 | (18-99) | 62 | (18-97) |
| Age ≧75 years | 279 | (22.2) | 292 | (23.3) |
| VTE risk score | | | | |
| 4 | 792 | (63.1) | 782 | (62.5) |
| 5 | 327 | (26.1) | 321 | (25.7) |
| 6 | 110 | (8.8) | 117 | (9.4) |
| 7 | 22 | (1.8) | 23 | (1.8) |
| 8 | 4 | (0.3) | 8 | (0.6) |
| Cancer | 1010 | (80.5) | 988 | (79.0) |
| Lymphoma | 242 | (19.3) | 235 | (18.8) |
| Genito-urinary | 163 | (13.0) | 144 | (11.5) |
| Acute leukemia | 159 | (12.7) | 165 | (13.2) |
| Gastro-intestinal | 124 | (9.9) | 141 | (11.3) |
| Breast | 102 | (8.1) | 105 | (8.4) |
| Lung | 92 | (7.3) | 91 | (7.3) |
| Sarcoma | 20 | (1.6) | 32 | (2.6) |
| Mesothelioma | 13 | (1.0) | 8 | (0.6) |
| Brain (primary) | 3 | (0.2) | 4 | (0.3) |
| Hypertension | 403 | (32.1) | 459 | (36.7) |
| Infection ≦30 days | 390 | (31.3) | 370 | (29.6) |
| Prior VTE | 253 | (20.2) | 255 | (20.4) |
| Coronary artery disease | 212 | (16.9) | 205 | (16.4) |
| Diabetes mellitus | 171 | (13.6) | 187 | (14.9) |
| Chronic lung disease | 160 | (12.7) | 151 | (12.1) |
| Congestive heart failure | 152 | (12.1) | 116 | (9.3) |
| Renal insufficiency | 144 | (11.5) | 151 | (12.1) |
| Surgery or trauma ≦30 days | 227 | (18.1) | 207 | (16.5) |
| Breast surgery | 61 | (4.9) | 62 | (5.0) |
| Genito-urinary surgery | 51 | (4.1) | 34 | (2.7) |
| Abdominal surgery | 35 | (2.8) | 45 | (3.6) |
| Orthopedic surgery | 26 | (2.1) | 21 | (1.7) |
| Thoracic surgery | 16 | (1.3) | 15 | (1.2) |
| Cardiovascular surgery | 15 | (1.2) | 7 | (0.6) |
| Reconstructive surgery | 12 | (1.0) | 11 | (0.9) |
| Neurosurgery | 5 | (0.4) | 7 | (0.6) |
| ENT surgery | 2 | (0.2) | 3 | (0.2) |

Data are given as numbers with proportions in parentheses. ENT = ear nose and throat; VTE = venous thromboembolism

men. Almost two-thirds had a VTE risk score of 4; in one-third, the risk score ranged from 5 to 8. Overall, 434 (17.3%) of the patients had undergone surgery or suffered trauma. The remaining 2,072 (82.7%) were nonsurgical and non trauma patients. The most common comorbidities were cancer in 79.7%, hypertension in 34.4%, and infection in 30.3%; 20.3% had prior VTE.

### Venous Thromboembolism Prophylaxis

Prophylactic measures were ordered in 421 (33.5%) and 182 (14.5%) of intervention and control group patients, respectively (p<0.001). Both mechanical (10.0% vs. 1.6%, p<0.001) and pharmacological prophylactic measures (23.6% vs. 13.0%, p<0.001) were more often used in intervention than control group patients (Table 2 below). The difference in the use of prophylaxis between the groups was mainly driven by an increased use of graduated compression stockings, intermittent pneumatic compression boots, and subcutaneous unfractionated heparin in intervention group patients.

TABLE 2
Venous Thromboembolism Prophylactic Measures

| | Intervention | Control | |
|---|---|---|---|
| | N = 1255 | N = 1251 | p |
| Mechanical | 125 (10.0) | 19 (1.6) | <0.001 |
| Compression stockings | 52 (4.1) | 7 (0.6) | <0.001 |
| Pneumatic boots | 73 (5.8) | 12 (1.0) | <0.001 |
| Pharmacological | 296 (23.6) | 163 (13.0) | <0.001 |
| Unfractionated heparin | 213 (17.0) | 81 (6.5) | <0.001 |
| Warfarin | 28 (2.2) | 41 (3.3) | 0.11 |
| Enoxaparin | 55 (4.4) | 41 (3.3) | 0.18 |

Data are given as numbers with proportions in parentheses.

In comparison to patients without prophylaxis, prophylaxed patients were older (66±15 vs. 59±17 years, p<0.001) and less often had cancer (70.7% vs. 82.6%, p<0.001). Prophylaxed patients more often had congestive heart failure (16.6% vs. 8.8%, p<0.001), coronary artery disease (21.6% vs. 15.1%, p<0.001), chronic lung disease (15.3% vs. 11.5%, p=0.01), prior VTE (32.8% vs. 16.3%, p<0.001), hypertension (39.3% vs. 32.9%, p=0.004), and recent surgery or trauma (37.3% vs. 14.2%, p<0.001). These covariates were predictive for use of prophylaxis in both intervention and control patients.

### Study End Points

### Efficacy

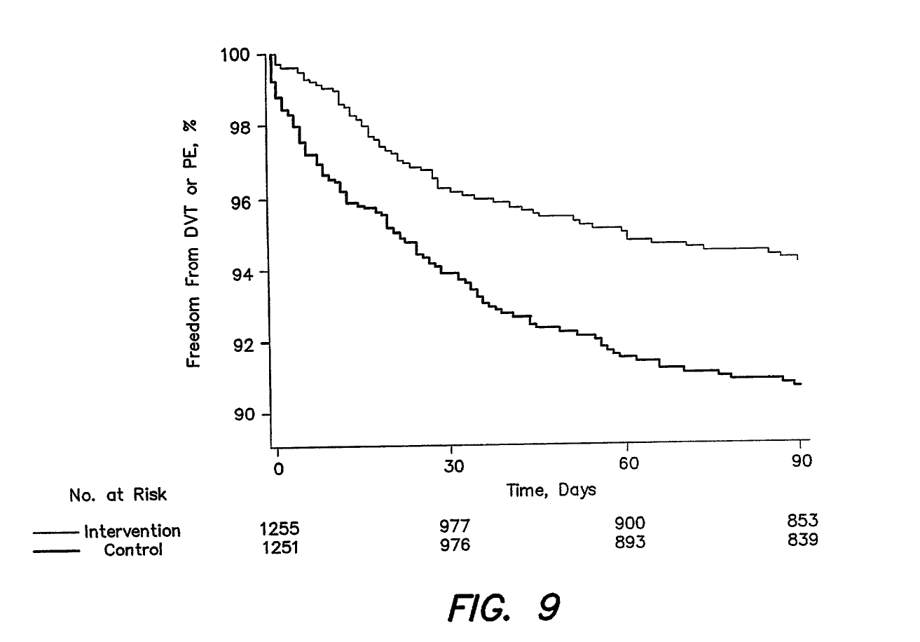

The primary endpoint occurred in 61 (4.9%) patients allocated to the intervention group and in 103 (8.2%) controls; the Kaplan-Meier estimates for freedom from VTE at day 90 were 94.1% (95% CI 92.5-95.4%) and 90.6% (95% CI 88.7-92.2%), respectively (p<0.001) (See FIG. 9, which illustrates Kaplan-Meier curves for freedom from DVT or PE in intervention (computer alert) and control (no computer alert) patients (log-rank p<0.001)). The computer alert reduced the risk of VTE at 90 days by 41% (hazard ratio 0.59, 95% CI 0.43-0.81%; p=0.001). The computer alert was similarly effective in reducing the rates of lower extremity DVT and PE (Table 3 below).

TABLE 3
Study Endpoints

| | | | |
|---|---|---|---|
| Intervention | Control | Hazard Ratio | |
| N = 1255 | N = 1251 | (95% CI) | p |

Total VTE

| | | | | |
|---|---|---|---|---|
| At 30 days | 41 (3.3) | 71 (5.7) | 0.58 (0.39-0.85) | 0.004 |
| At 90 days | 61 (4.9) | 103 (8.2) | 0.59 (0.43-0.81) | 0.001 |

Acute PE

| | | | | |
|---|---|---|---|---|
| At 30 days | 10 (0.8) | 21 (1.7) | 0.48 (0.22-1.01) | 0.05 |
| At 90 days | 14 (1.1) | 35 (2.8) | 0.40 (0.21-0.74) | 0.004 |

Proximal leg DVT

| | | | | |
|---|---|---|---|---|
| At 30 days | 8 (0.6) | 17 (1.4) | 0.47 (0.20-1.09) | 0.08 |
| At 90 days | 10 (0.8) | 23 (1.8) | 0.47 (0.20-1.09) | 0.08 |

Distal leg DVT

| | | | | |
|---|---|---|---|---|
| At 30 days | 3 (0.2) | 8 (0.6) | 0.37 (0.10-1.41) | 0.15 |
| At 90 days | 5 (0.4) | 12 (1.0) | 0.42 (0.15-1.18) | 0.10 |

Upper extremity DVT*

| | | | | |
|---|---|---|---|---|
| At 30 days | 20 (1.6) | 25 (2.0) | 0.80 (0.44-1.44) | 0.46 |
| At 90 days | 32 (2.5) | 33 (2.6) | 0.97 (0.60-1.58) | 0.90 |

Mortality

| | | | | |
|---|---|---|---|---|
| At 30 days | 174 (13.9) | 157 (12.5) | 1.07 (0.86-1.32) | 0.56 |
| At 90 days | 282 (22.5) | 279 (22.3) | 0.97 (0.82-1.15) | 0.74 |

Major hemorrhage

| | | | | |
|---|---|---|---|---|
| At 30 days | 19 (1.5) | 19 (1.5) | 0.95 (0.50-1.80) | 0.87 |

Minor hemorrhage

| | | | | |
|---|---|---|---|---|
| At 30 days | 81 (6.5) | 88 (7.0) | 0.88 (0.65-1.20) | 0.43 |

Data are given as numbers with proportions in parentheses. DVT = deep vein thrombosis; PE = pulmonary embolism; VTE = venous thromboembolism
*Among the 65 patients with upper extremity DVT, 51 (78.5%) received chemotherapy via a central venous catheter or port-a-cath.

The electronic alert reduced VTE at 90 days in clinically important subgroups (Table 4 below). Proportional-hazards models did not reveal interaction between the effect of the computer alert and any subgroup.

At 90 days, VTE occurred in 31 (5.2%) and 133 (7.0%) of prophylaxed and unprophylaxed patients, respectively; the Kaplan-Meier estimates for freedom from VTE at 90 days were 93.6% (95% CI 91.0-95.5%) and 92.0% (95% CI 90.5-93.2%) (p=0.08). In the intervention group, VTE occurred in 20 (4.8%) of prophylaxed and 41 (4.9%) of unprophylaxed patients; the Kaplan-Meier estimates for freedom from VTE were 94.3% (95% CI 92.3-95.3%) and 93.8% (95% CI 90.6-96.0%), respectively (p=0.82). In the control group, VTE occurred in 11 (6.0%) of prophylaxed and 91 (8.6%) of unprophylaxed patients; the Kaplan-Meier estimates were 93.1% (95% CI 87.8-96.1%) and 90.2% (95% CI 88.1-91.9%), respectively (p=0.23).

TABLE 4
Hazard Ratios for the Primary Endpoint
in Clinically Important Subgroups

| | Primary endpoint, % | | Hazard Ratio | p for |
|---|---|---|---|---|
| | Intervention | Control | (95% CI) | interaction* |
| VTE risk score | | | | 0.22 |
| 4 | 29 (1.8) | 59 (3.7) | 0.49 (0.31-0.76) | |
| >4 | 32 (3.4) | 44 (4.7) | 0.73 (0.46-1.15) | |
| Sex | | | | 0.93 |
| Men | 33 (2.8) | 56 (4.7) | 0.59 (0.38-0.91) | |
| Women | 28 (2.1) | 47 (3.5) | 0.57 (0.36-0.91) | |
| Age | | | | 0.24 |
| <75 years | 52 (2.7) | 79 (4.1) | 0.63 (0.45-0.90) | |
| ≧75 years | 9 (1.6) | 24 (4.2) | 0.38 (0.18-0.82) | |
| Cancer | | | | 0.22 |
| Present | 55 (2.8) | 84 (4.2) | 0.63 (0.45-0.88) | |
| Absent | 6 (1.2) | 19 (3.7) | 0.33 (0.13-0.83) | |
| Major surgery | | | | 0.22 |
| or trauma | | | | |
| Present | 10 (2.3) | 9 (2.1) | 1.00 (0.41-2.47) | |
| Absent | 51 (2.5) | 94 (4.5) | 0.55 (0.41-0.78) | |
| Prior VTE | | | | 0.37 |
| Present | 18 (3.5) | 25 (4.9) | 0.75 (0.41-1.37) | |
| Absent | 43 (2.2) | 78 (3.9) | 0.54 (0.37-0.79) | |

*The null hypothesis is that there are no differences among subgroups. VTE = venous thromboembolism

### Safety

Mortality at 30 and 90 days was 13.2% and 22.4%, respectively, with no difference between the groups (Table 3). There was no increase in major or minor hemorrhage at 30 days in intervention group patients.

### Discussion

The computer program facilitated: 1) identification of hospitalized patients at increased risk for VTE without prophylaxis, 2) more than doubling of the rate of prophylactic orders from 14.5% to 33.5%, and 3) reduction in the overall VTE event rate at 90 days by 41%, without an increase in bleeding or mortality rates. Of note, the reduction in VTE events was mainly due to a decreased frequency of PE and proximal leg DVT.

Our study population consisted mostly (83%) of medical patients who were severely ill, with a high prevalence of cancer (80%) and a 3-month mortality that exceeded 20%. The upper extremity DVT rate in cancer patients was high and most likely due to the frequent use of chemotherapy via central venous catheters. The prophylaxis rate in intervention patients was low (33.5%) in this ill population; many may have had conditions precluding pharmacologic prophylaxis, but there is no obvious explanation for failure to order mechanical prophylaxis such as graduated compression stockings or intermittent pneumatic compression boots. Although we did not track contraindications to prophylaxis, they were probably evenly distributed between intervention and control patients due to the randomized design of the trial.

The computer alert was effective in a wide spectrum of major VTE risk factors, such as advanced age, prior VTE, or cancer. The computer alert had similar efficacy in reducing the primary endpoint in patients with a VTE risk score of 4 and with higher VTE risk scores. However, VTE prophylaxis has not reduced the overall mortality rate significantly in any major VTE prevention trial of hospitalized medical patients, including the present study; none was adequately powered to investigate the effect of VTE prophylaxis on overall mortality.

In the present trial, the reduction of VTE events may only partly be explained by an increased use of prophylaxis in intervention patients. Assignment to the intervention group itself decreased VTE events through day 90. In intervention patients, the computer alert may have contributed to an increased awareness of a high risk situation among health care professionals, even though mechanical or pharmacological prophylaxis was not administered. Our study design did not allow the assessment of additional preventive measures that may have decreased the VTE event rate in intervention patients, such as early ambulation or physiotherapy. In addition, the fact that intervention but not control group physicians were aware that their patients were monitored may further have affected the VTE event rate. However, since prophylaxis was not randomized but was an individual physician choice, prophylaxed and unprophylaxed patients may not be comparable. Therefore, study group analyses according to prophylaxis status must be interpreted with caution.

We cannot exclude the possibility of diagnostic bias, since administration of prophylaxis was not blinded and testing for VTE was not performed routinely. It is therefore possible that physicians were more likely to order an imaging test in symptomatic patients who had not received prophylaxis. On the other hand, it is possible that testing was not performed in symptomatic patients with limited life expectancy or contraindications to anticoagulation therapy, even if prophylaxis was not administered.

Due to a high prophylaxis rate in the entire cohort of patients with a VTE risk score ≧4, the overall effect of the computer program was weak, resulting in increased utilization of prophylaxis from 80.6% to 82.6%. Study intervention was carried out on physicians, but randomization was performed on patients. Therefore, we were not able to assess for a physician effect on the use of prophylaxis and VTE event rate. Since most physicians treated both intervention and control patients, it is likely that computer reminders for intervention patients also affected prophylaxis use in some control patients.

Computer-based clinical decision systems may be less effective for the management of chronic than acute disease, but they appear to be particularly useful for preventive care and drug dosing in the hospital setting. In a randomized controlled trial of 6,371 hospitalized patients, computerized reminders increased orders for unfractionated heparin from 18.9% in control patients to 32.2% in intervention patients.

In a French orthopedic surgery department, electronic reminders increased compliance with DVT prevention guidelines from 82.8% of controls to 94.9% of cases. The latter two studies, however, did not track patient outcomes. Thus, the current data—taken in context with these two prior studies—support the use of a computer generated alert to reduce clinical events among hospitalized patients at risk for VTE.

Key elements in making the study software work were a full and integrated database, which allowed us to gather the data elements needed to determine the patient's VTE risk score, a robust rule-based alerting system capable of being triggered in a variety of ways, and an existing and well accepted notification system with which our physicians were already familiar. Our design may be useful at other institutions; however, it may require modification because: 1) the computer language and hospital database layout may be different, 2) an integrated data system is not available, and 3) the vocabulary of the data base used to identify high risk patients without prophylaxis may vary.

Our results suggest that hospitals with adequate Information Systems resources should consider implementation of electronic alerts to increase the awareness of VTE risk, to improve the utilization of prophylaxis, and to reduce the rates of DVT and PE.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of determining whether to issue an alert for consideration of prophylaxis for at least one patient with respect to a risk condition, the method comprising computer-implemented acts of.
(A) for each risk factor of a set of risk factors, determining whether the risk factor is satisfied for the at least one patient;
(B) for each satisfied risk factor, assigning a respective pre-selected value;
(C) combining the assigned values for the at least one patient to produce a risk score; and
(D) issuing an alert to consider prophylaxis for the at least one patient if the risk score satisfies one or more predefined criteria.

2. The method of claim 1, wherein the act (A) is performed for at least a subset of a patient population.

3. The method of claim 1, further comprising:
(E) determining that the risk score is equal to or greater than a predefined threshold value.

4. The method of claim 1, further comprising an act of:
(E) repeating the acts (A)-(D) at a predetermined frequency.

5. The method of claim 4, wherein the frequency is daily.

6. The method of claim 1, wherein the act (A) comprises accessing one or more patient information data sources.

7. The method of claim 6, wherein the act (A) comprises, for a plurality of patients, determining for each risk factor of a set of risk factors, whether the risk factor is satisfied by one or more of the plurality of patients by accessing information from the one or more patient data sources for each patient.

8. The method of claim 1, wherein the risk condition is Venous Thromboembolism.

9. The method of claim 1, wherein the risk condition is Deep Vein Thrombosis.

10. The method of claim 1, wherein the risk condition is Pulmonary Embolism.

11. The method of claim 1, wherein the set of risk factors comprises two or more of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

12. The method of claim 1, wherein the set of risk factors comprises the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

13. The method of claim 12, wherein the set of risk factors consists of the following: patient has been diagnosed with cancer; patient has had a prior occurrence of a Venous Thromboembolism; patient has been diagnosed with hypercoagulability; patient has had major surgery; patient has not had major surgery and is currently on bed rest; patient is of advanced age; patient is obese; and patient is receiving hormone replacement therapy or is currently using oral contraceptives.

14. The method of claim 12 or 13, wherein the set of risk factors has the following pre-selected values: patient has been diagnosed with cancer=3; patient has had a prior occurrence of a Venous Thromboembolism=3; patient has been diagnosed with hypercoagulability=3; patient has had major surgery=2; patient has not had major surgery and is currently on bed rest=1; patient is of advanced age=1; patient is obese=1; and patient is receiving hormone replacement therapy or uses oral contraceptives=1.

15. The method of 14, further comprising:
(E) determining that the risk score is equal to or greater than 4.

16. The method of claim 1, wherein the set of risk factors are divided into one or more classifications, and wherein the method further comprises:
(E) determining whether one or more predefined combinations of risk factors have been satisfied, based on the classifications of the satisfied risk factors.

17. The method of claim 16, wherein each risk factor is classified as a major risk factor, intermediate risk factor or minor risk factor, and wherein the Act (D) comprises issuing an alert to consider prophylaxis for the at least one patient if: at least one major risk factor is satisfied and at least one of an intermediate or minor risk factor is satisfied; or at least two intermediate risk factors are satisfied; or at least one major intermediate risk factor and at least two minor risk factors are satisfied; or at least four minor risk factors are satisfied.

18. The method of claim 1, wherein the act (C) comprises adding the assigned values for the at least one patient to produce the risk score.

19. The method of claim 1, wherein the act (D) comprises displaying the alert on a display device.

20. The method of claim 1, wherein the act (D) comprises directing the alert to one or more appropriate health care providers.

21-186. (canceled)
